(19) United States
(12) Patent Application Publication
(10) Pub. No.: US 2026/0087736 A1
(43) Pub. Date: Mar. 26, 2026

(54) INITIATING COMMUNICATION IN THREE-DIMENSIONAL ENVIRONMENTS BASED ON USER AVAILABILITY

(71) Applicant: Apple Inc., Cupertino, CA (US)

(72) Inventors: Joseph P. CERRA, San Francisco, CA (US); Hayden James BARSOTTI, Mountain View, CA (US)

(21) Appl. No.: 19/292,003

(22) Filed: Aug. 6, 2025

Related U.S. Application Data
(60) Provisional application No. 63/697,975, filed on Sep. 23, 2024.

(51) Int. Cl. G06T 17/00; G06F 3/16

(52) U.S. Cl. CPC G06T 17/00; G06F 3/16

(57) ABSTRACT

Some examples of the disclosure are directed to systems and methods of initiating communication with a user virtually in a three-dimensional environment based on user availability. Some examples of the disclosure are directed to systems and methods of initiating communication with a user virtually in a three-dimensional environment in response to receiving a request to initiate communication with the user.

### CROSS REFERENCE TO RELATED APPLICATIONS

This application claims the benefit of U.S. Provisional Application No. 63/697,975, filed Sep. 23, 2024, the content of which is herein incorporated by reference in its entirety for all purposes.

### FIELD OF THE DISCLOSURE

This relates generally to systems and methods of initiating communication between users virtually in a three-dimensional environment based on user availability.

### BACKGROUND OF THE DISCLOSURE

Some computer graphical environments provide two-dimensional and/or three-dimensional environments where at least some objects displayed for a user's viewing are virtual and generated by a computer. In some examples, three-dimensional environments are presented by multiple electronic devices in communication with each other. In some examples, a portal through which to visually communicate with a particular user is displayed in a three-dimensional environment presented at a respective electronic device.

### SUMMARY OF THE DISCLOSURE

Some examples of the disclosure are directed to systems and methods of initiating communication with a user virtually in a three-dimensional environment based on user availability. In some examples, a method is performed at a first electronic device in communication with one or more displays and one or more input devices. In some examples, while presenting, via the one or more displays, a user interface including a plurality of representations of a plurality of users in a three-dimensional environment, wherein one or more users of the plurality of users satisfy one or more first criteria and one or more first representations of the plurality of representations of the one or more users are displayed with a first visual appearance, the first electronic device detects, via the one or more input devices, a first input directed to the user interface corresponding to a request to initiate communication with a user of a second electronic device. In some examples, in response to receiving the first input, the first electronic device ceases display of the user interface and transmits an indication of the request to initiate communication with the user of the second electronic device. In some examples, after transmitting the indication, the first electronic device receives an indication of a reply to the request to initiate communication with the user of the second electronic device. In some examples, in response to receiving the indication, in accordance with a determination that the reply corresponds to an acceptance of the request to initiate communication with the user of the second electronic device, the first electronic device establishes communication with the second electronic device, including displaying, via the one or more displays, a visual representation of the user of the second electronic device in the three-dimensional environment. In some examples, in accordance with a determination that the reply corresponds to a denial of the request to initiate communication with the user of the second electronic device, the first electronic device displays a user interface object associated with the reply in the three-dimensional environment.

Some examples of the disclosure are directed to systems and methods of initiating communication with a user virtually in a three-dimensional environment in response to receiving a request to initiate communication with the user. In some examples, a method is performed at a first electronic device in communication with one or more displays and one or more input devices. In some examples, the first electronic device detects a first indication of a request to initiate communication with a user of a second electronic device. In some examples, in response to detecting the first indication, the first electronic device displays, on an outward-facing surface of the one or more displays, a notification corresponding to the first indication. In some examples, while displaying the notification, the first electronic device detects, via the one or more input devices, a second indication of an acceptance of the request to initiate communication with the user of the second electronic device. In some examples, in response to detecting the second indication, the first electronic device establishes communication with the second electronic device. In some examples, in accordance with a determination that the first electronic device is associated with a first portion of a user of the first electronic device when the second indication is detected, the first electronic device displays, via the one or more displays, a visual representation of the user of the second electronic device in a three-dimensional environment. In some examples, in accordance with a determination that the first electronic device is not associated with the first portion of the user of the first electronic device when the second indication is detected, the first electronic device outputs, via one or more speakers in communication with the first electronic device, audio corresponding to a voice of the second user transmitted by the second electronic device.

The full descriptions of these examples are provided in the Drawings and the Detailed Description, and it is understood that this Summary does not limit the scope of the disclosure in any way.

### BRIEF DESCRIPTION OF THE DRAWINGS

For improved understanding of the various examples described herein, reference should be made to the Detailed Description below along with the following drawings. Like reference numerals often refer to corresponding parts throughout the drawings.

FIG. 1 illustrates an electronic device presenting an extended reality environment according to some examples of the disclosure.

FIG. 2 illustrates a block diagram of an example architecture for a system according to some examples of the disclosure.

FIG. 3 illustrates an example of a spatial group in a multi-user communication session that includes a first electronic device and a second electronic device according to some examples of the disclosure.

FIGS. 4A-4G illustrate examples of facilitating transmitting a request to initiate communication between users virtually in a three-dimensional environment according to some examples of the disclosure.

FIGS. 5A-5J illustrate examples of facilitating communication between users virtually in a three-dimensional environment according to some examples of the disclosure.

FIG. 6 illustrates a flow diagram illustrating an example process for facilitating transmitting a request to initiate communication between users virtually in a three-dimensional environment according to some examples of the disclosure.

FIG. 7 illustrates a flow diagram illustrating an example process for facilitating response to a request to initiate communication between users virtually in a three-dimensional environment according to some examples of the disclosure.

### DETAILED DESCRIPTION

Some examples of the disclosure are directed to systems and methods of initiating communication with a user virtually in a three-dimensional environment based on user availability. In some examples, a method is performed at a first electronic device in communication with one or more displays and one or more input devices. In some examples, while presenting, via the one or more displays, a user interface including a plurality of representations of a plurality of users in a three-dimensional environment, wherein one or more users of the plurality of users satisfy one or more first criteria and one or more first representations of the plurality of representations of the one or more users are displayed with a first visual appearance, the first electronic device detects, via the one or more input devices, a first input directed to the user interface corresponding to a request to initiate communication with a user of a second electronic device. In some examples, in response to receiving the first input, the first electronic device ceases display of the user interface and transmits an indication of the request to initiate communication with the user of the second electronic device. In some examples, after transmitting the indication, the first electronic device receives an indication of a reply to the request to initiate communication with the user of the second electronic device. In some examples, in response to receiving the indication, in accordance with a determination that the reply corresponds to an acceptance of the request to initiate communication with the user of the second electronic device, the first electronic device establishes communication with the second electronic device, including displaying, via the one or more displays, a visual representation of the user of the second electronic device in the three-dimensional environment. In some examples, in accordance with a determination that the reply corresponds to a denial of the request to initiate communication with the user of the second electronic device, the first electronic device displays a user interface object associated with the reply in the three-dimensional environment.

Some examples of the disclosure are directed to systems and methods of initiating communication with a user virtually in a three-dimensional environment in response to receiving a request to initiate communication with the user. In some examples, a method is performed at a first electronic device in communication with one or more displays and one or more input devices. In some examples, the first electronic device detects a first indication of a request to initiate communication with a user of a second electronic device. In some examples, in response to detecting the first indication, the first electronic device displays, on an outward-facing surface of the one or more displays, a notification corresponding to the first indication. In some examples, while displaying the notification, the first electronic device detects, via the one or more input devices, a second indication of an acceptance of the request to initiate communication with the user of the second electronic device. In some examples, in response to detecting the second indication, the first electronic device establishes communication with the second electronic device. In some examples, in accordance with a determination that the first electronic device is associated with a first portion of a user of the first electronic device when the second indication is detected, the first electronic device displays, via the one or more displays, a visual representation of the user of the second electronic device in a three-dimensional environment. In some examples, in accordance with a determination that the first electronic device is not associated with the first portion of the user of the first electronic device when the second indication is detected, the first electronic device outputs, via one or more speakers in communication with the first electronic device, audio corresponding to a voice of the second user transmitted by the second electronic device.

As used herein, a spatial group corresponds to a group or number of participants (e.g., users) in a multi-user communication session. In some examples, a spatial group in the multi-user communication session has a spatial arrangement that dictates locations of users and content that are located in the spatial group. In some examples, users in the same spatial group within the multi-user communication session experience spatial truth according to the spatial arrangement of the spatial group. In some examples, when the user of the first electronic device is in a first spatial group and the user of the second electronic device is in a second spatial group in the multi-user communication session, the users experience spatial truth that is localized to their respective spatial groups. In some examples, while the user of the first electronic device and the user of the second electronic device are grouped into separate spatial groups within the multi-user communication session, if the first electronic device and the second electronic device return to the same operating state, the user of the first electronic device and the user of the second electronic device are regrouped into the same spatial group within the multi-user communication session.

In some examples, initiating a multi-user communication session may include interaction with one or more user interface elements. In some examples, a user's gaze may be tracked by an electronic device as an input for targeting a selectable option/affordance within a respective user interface element that is displayed in the three-dimensional environment. For example, gaze can be used to identify one or more options/affordances targeted for selection using another selection input. In some examples, a respective option/affordance may be selected using hand-tracking input detected via an input device in communication with the electronic device. In some examples, objects displayed in the three-dimensional environment may be moved and/or reoriented in the three-dimensional environment in accordance with movement input detected via the input device.

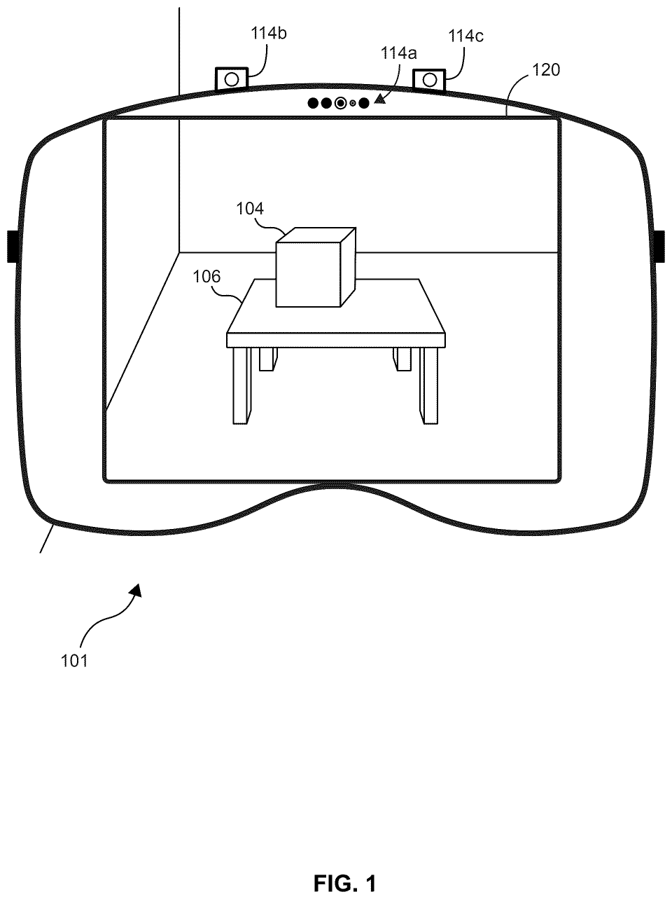

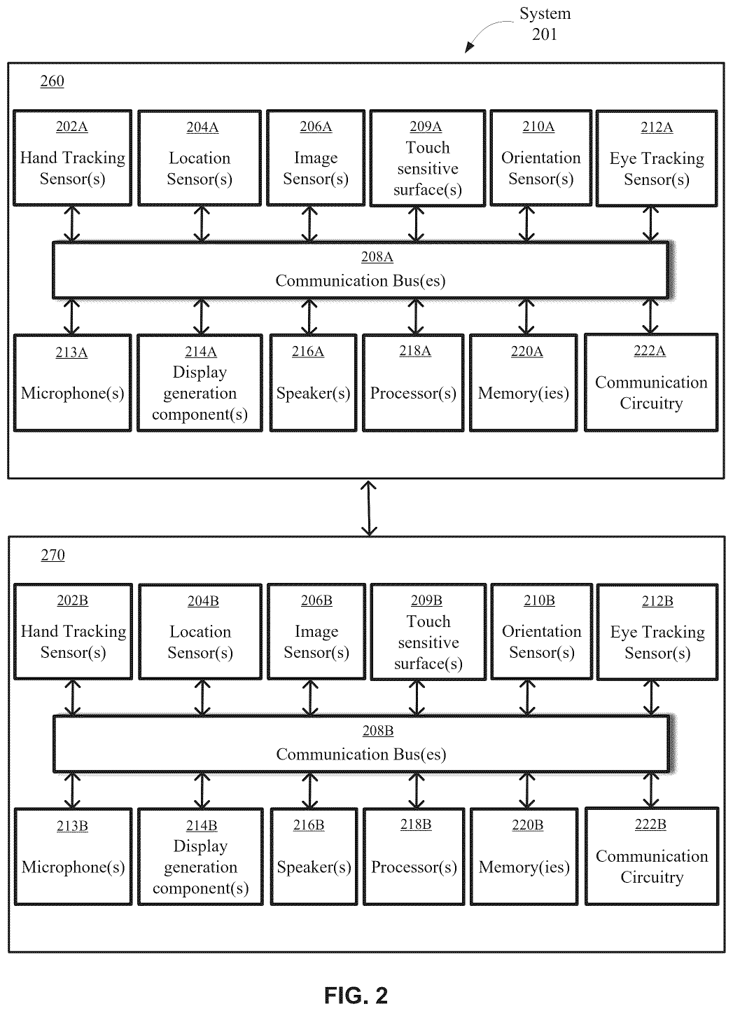

FIG. 1 illustrates an electronic device 101 presenting an extended reality (XR) environment (e.g., a computer-generated environment optionally including representations of physical and/or virtual objects) according to some examples of the disclosure. In some examples, as shown in FIG. 1, electronic device 101 is a head-mounted display or other head-mountable device configured to be worn on a head of a user of the electronic device 101. Examples of electronic device 101 are described below with reference to the architecture block diagram of FIG. 2. As shown in FIG. 1, electronic device 101 and table 106 are located in a physical environment. The physical environment may include physical features such as a physical surface (e.g., floor, walls) or a physical object (e.g., table, lamp, etc.). In some examples, electronic device 101 may be configured to detect and/or capture images of physical environment including table 106 (illustrated in the field of view of electronic device 101).

In some examples, as shown in FIG. 1, electronic device 101 includes one or more internal image sensors 114a oriented towards a face of the user (e.g., eye tracking cameras described below with reference to FIG. 2). In some examples, internal image sensors 114a are used for eye tracking (e.g., detecting a gaze of the user). Internal image sensors 114a are optionally arranged on the left and right portions of display 120 to enable eye tracking of the user's left and right eyes. In some examples, electronic device 101 also includes external image sensors 114b and 114c facing outwards from the user to detect and/or capture the physical environment of the electronic device 101 and/or movements of the user's hands or other body parts.

In some examples, display 120 has a field of view visible to the user (e.g., that may or may not correspond to a field of view of external image sensors 114b and 114c). Because display 120 is optionally part of a head-mounted device, the field of view of display 120 is optionally the same as or similar to the field of view of the user's eyes. In other examples, the field of view of display 120 may be smaller than the field of view of the user's eyes. In some examples, electronic device 101 may be an optical see-through device in which display 120 is a transparent or translucent display through which portions of the physical environment may be directly viewed. In some examples, display 120 may be included within a transparent lens and may overlap all or only a portion of the transparent lens. In other examples, electronic device may be a video-passthrough device in which display 120 is an opaque display configured to display images of the physical environment captured by external image sensors 114b and 114c. While a single display 120 is shown, it should be appreciated that display 120 may include a stereo pair of displays.

In some examples, in response to a trigger, the electronic device 101 may be configured to display a virtual object 104 in the XR environment represented by a cube illustrated in FIG. 1, which is not present in the physical environment, but is displayed in the XR environment positioned on the top of real-world table 106 (or a representation thereof). Optionally, virtual object 104 can be displayed on the surface of the table 106 in the XR environment displayed via the display 120 of the electronic device 101 in response to detecting the planar surface of table 106 in the physical environment 100.

It should be understood that virtual object 104 is a representative virtual object and one or more different virtual objects (e.g., of various dimensionality such as two-dimensional or other three-dimensional virtual objects) can be included and rendered in a three-dimensional XR environment. For example, the virtual object can represent an application or a user interface displayed in the XR environment. In some examples, the virtual object can represent content corresponding to the application and/or displayed via the user interface in the XR environment. In some examples, the virtual object 104 is optionally configured to be interactive and responsive to user input (e.g., air gestures, such as air pinch gestures, air tap gestures, and/or air touch gestures), such that a user may virtually touch, tap, move, rotate, or otherwise interact with, the virtual object 104.

In some examples, displaying an object in a three-dimensional environment may include interaction with one or more user interface objects in the three-dimensional environment. For example, initiation of display of the object in the three-dimensional environment can include interaction with one or more virtual options/affordances displayed in the three-dimensional environment. In some examples, a user's gaze may be tracked by the electronic device as an input for identifying one or more virtual options/affordances targeted for selection when initiating display of an object in the three-dimensional environment. For example, gaze can be used to identify one or more virtual options/affordances targeted for selection using another selection input. In some examples, a virtual option/affordance may be selected using hand-tracking input detected via an input device in communication with the electronic device. In some examples, objects displayed in the three-dimensional environment may be moved and/or reoriented in the three-dimensional environment in accordance with movement input detected via the input device.

In the discussion that follows, an electronic device that is in communication with a display generation component and one or more input devices is described. It should be understood that the electronic device optionally is in communication with one or more other physical user-interface devices, such as a touch-sensitive surface, a physical keyboard, a mouse, a joystick, a hand tracking device, an eye tracking device, a stylus, etc. Further, as described above, it should be understood that the described electronic device, display and touch-sensitive surface are optionally distributed amongst two or more devices. Therefore, as used in this disclosure, information displayed on the electronic device or by the electronic device is optionally used to describe information outputted by the electronic device for display on a separate display device (touch-sensitive or not). Similarly, as used in this disclosure, input received on the electronic device (e.g., touch input received on a touch-sensitive surface of the electronic device, or touch input received on the surface of a stylus) is optionally used to describe input received on a separate input device, from which the electronic device receives input information.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, a television channel browsing application, and/or a digital video player application.

FIG. 2 illustrates a block diagram of an example architecture for a system 201 according to some examples of the disclosure. In some examples, system 201 includes multiple electronic devices. For example, the system 201 includes a first electronic device 260 and a second electronic device 270, wherein the first electronic device 260 and the second electronic device 270 are in communication with each other. In some examples, the first electronic device 260 and/or the second electronic device 270 are a portable device, an auxiliary device in communication with another device, a head-mounted display, etc., respectively. In some examples, the first electronic device 260 and the second electronic device 270 correspond to electronic device 101 described above with reference to FIG. 1.

As illustrated in FIG. 2, the first electronic device 260 and the second electronic device 270 optionally include various sensors, such as one or more hand tracking sensors 202A/202B, one or more location sensors 204A/204B, one or more image sensors 206A/206B (optionally corresponding to internal image sensors 114a and/or external image sensors 114b and 114c in FIG. 1), one or more touch-sensitive surfaces 209A/209B, one or more motion and/or orientation sensors 210A/210B, one or more eye tracking sensors 212A/212B, one or more microphones 213A/213B or other audio sensors, one or more body tracking sensors (e.g., torso and/or head tracking sensors), one or more display generation components 214A/214B, optionally corresponding to display 120 in FIG. 1, one or more speakers 216A/216B, one or more processors 218A/218B, one or more memories 220A/220B, and/or communication circuitry 222A/222B. One or more communication buses 208A/208B are optionally used for communication between the above-mentioned components of the electronic devices 260 and 270.

Communication circuitry 222A/222B optionally includes circuitry for communicating with electronic devices, networks, such as the Internet, intranets, a wired network and/or a wireless network, cellular networks, and wireless local area networks (LANs). Communication circuitry 222A/222B optionally includes circuitry for communicating using near-field communication (NFC) and/or short-range communication, such as Bluetooth®.

Processor(s) 218A/218B include one or more general processors, one or more graphics processors, and/or one or more digital signal processors. In some examples, memory 220A/220B is a non-transitory computer-readable storage medium (e.g., flash memory, random access memory, or other volatile or non-volatile memory or storage) that stores computer-readable instructions configured to be executed by processor(s) 218A/218B to perform the techniques, processes, and/or methods described below. In some examples, memory 220A/220B can include more than one non-transitory computer-readable storage medium. A non-transitory computer-readable storage medium can be any medium (e.g., excluding a signal) that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on compact disc (CD), digital versatile disc (DVD), or Blu-ray technologies, as well as persistent solid-state memory such as flash, solid-state drives, and the like.

In some examples, display generation component(s) 214A/214B include a single display (e.g., a liquid-crystal display (LCD), organic light-emitting diode (OLED), or other types of display). In some examples, display generation component(s) 214A/214B include multiple displays. In some examples, display generation component(s) 214A/214B can include a display with touch capability (e.g., a touch screen), a projector, a holographic projector, a retinal projector, a transparent or translucent display, etc. In some examples, the first and second electronic devices 260 and 270 include touch-sensitive surface(s) 209A/209B, respectively, for receiving user inputs, such as tap inputs and swipe inputs or other gestures. In some examples, display generation component(s) 214A/214B and touch-sensitive surface(s) 209A/209B form touch-sensitive display(s) (e.g., a touch screen integrated with electronic devices 260 and 270 or external to electronic devices 260 and 270 that is in communication with electronic devices 260 and 270).

Electronic devices 260 and 270 optionally include image sensor(s) 206A/206B. Image sensors(s) 206A/206B optionally include one or more visible light image sensors, such as charged coupled device (CCD) sensors, and/or complementary metal-oxide-semiconductor (CMOS) sensors operable to obtain images of physical objects from the real-world environment. Image sensor(s) 206A/206B also optionally include one or more infrared (IR) sensors, such as a passive or an active IR sensor, for detecting infrared light from the real-world environment. For example, an active IR sensor includes an IR emitter for emitting infrared light into the real-world environment. Image sensor(s) 206A/206B also optionally include one or more cameras configured to capture movement of physical objects in the real-world environment. Image sensor(s) 206A/206B also optionally include one or more depth sensors configured to detect the distance of physical objects from electronic devices 260 and 270. In some examples, information from one or more depth sensors can allow the device to identify and differentiate objects in the real-world environment from other objects in the real-world environment. In some examples, one or more depth sensors can allow the device to determine the texture and/or topography of objects in the real-world environment.

In some examples, electronic devices 260 and 270 use CCD sensors, event cameras, and depth sensors in combination to detect the physical environment around electronic devices 260 and 270. In some examples, image sensor(s) 206A/206B include a first image sensor and a second image sensor. The first image sensor and the second image sensor work in tandem and are optionally configured to capture different information of physical objects in the real-world environment. In some examples, the first image sensor is a visible light image sensor and the second image sensor is a depth sensor. In some examples, electronic devices 260 and 270 use image sensor(s) 206A/206B to detect the position and orientation of electronic devices 260 and 270 and/or display generation component(s) 214A/214B in the real-world environment. For example, electronic devices 260 and 270 use image sensor(s) 206A/206B to track the position and orientation of display generation component(s) 214A/214B relative to one or more fixed objects in the real-world environment.

In some examples, electronic devices 260 and 270 include microphone(s) 213A/213B or other audio sensors. Electronic devices 260 and 270 optionally use microphone(s) 213A/213B to detect sound from the user and/or the real-world environment of the user. In some examples, microphone(s) 213A/213B include an array of microphones (a plurality of microphones) that optionally operate in tandem, such as to identify ambient noise or to locate the source of sound in space of the real-world environment.

Electronic devices 260 and 270 include location sensor(s) 204A/204B for detecting a location of electronic devices 260 and 270 and/or display generation component(s) 214A/214B. For example, location sensor(s) 204A/204B can include a global positioning system (GPS) receiver that receives data from one or more satellites and allows electronic devices 260 and 270 to determine the devices' absolute positions in the physical world.

Electronic devices 260 and 270 include orientation sensor(s) 210A/210B for detecting orientation and/or movement of electronic devices 260 and 270 and/or display generation component(s) 214A/214B. For example, electronic devices 260 and 270 use orientation sensor(s) 210A/210B to track changes in the position and/or orientation of electronic devices 260 and 270 and/or display generation component(s) 214A/214B, such as with respect to physical objects in the real-world environment. Orientation sensor(s) 210A/210B optionally include one or more gyroscopes and/or one or more accelerometers.

Electronic devices 260 and 270 include hand tracking sensor(s) 202A/202B and/or eye tracking sensor(s) 212A/212B (and/or other body tracking sensor(s), such as leg, torso and/or head tracking sensor(s)), in some examples. Hand tracking sensor(s) 202A/202B are configured to track the position/location of one or more portions of the user's hands, and/or motions of one or more portions of the user's hands with respect to the extended reality environment, relative to the display generation component(s) 214A/214B, and/or relative to another defined coordinate system. Eye tracking sensor(s) 212A/212B are configured to track the position and movement of a user's gaze (eyes, face, or head, more generally) with respect to the real-world or extended reality environment and/or relative to the display generation component(s) 214A/214B. In some examples, hand tracking sensor(s) 202A/202B and/or eye tracking sensor(s) 212A/212B are implemented together with the display generation component(s) 214A/214B. In some examples, the hand tracking sensor(s) 202A/202B and/or eye tracking sensor(s) 212A/212B are implemented separate from the display generation component(s) 214A/214B.

In some examples, the hand tracking sensor(s) 202A/202B (and/or other body tracking sensor(s), such as leg, torso and/or head tracking sensor(s)) can use image sensor(s) 206A/206B (e.g., one or more IR cameras, 3D cameras, depth cameras, etc.) that capture three-dimensional information from the real-world including one or more body parts (e.g., hands, legs, or torso of a human user). In some examples, the hands can be resolved with sufficient resolution to distinguish fingers and their respective positions. In some examples, one or more image sensors 206A/206B are positioned relative to the user to define a field of view of the image sensor(s) 206A/206B and an interaction space in which finger/hand position, orientation and/or movement captured by the image sensors are used as inputs (e.g., to distinguish from a user's resting hand or other hands of other persons in the real-world environment). Tracking the fingers/hands for input (e.g., gestures, touch, tap, etc.) can be advantageous in that it does not require the user to touch, hold or wear any sort of beacon, sensor, or other marker.

In some examples, eye tracking sensor(s) 212A/212B includes at least one eye tracking camera (e.g., infrared (IR) cameras) and/or illumination sources (e.g., IR light sources, such as LEDs) that emit light towards a user's eyes. The eye tracking cameras may be pointed towards a user's eyes to receive reflected IR light from the light sources directly or indirectly from the eyes. In some examples, both eyes are tracked separately by respective eye tracking cameras and illumination sources, and a focus/gaze can be determined from tracking both eyes. In some examples, one eye (e.g., a dominant eye) is tracked by one or more respective eye tracking cameras/illumination sources.

Electronic devices 260 and 270 are not limited to the components and configuration of FIG. 2, but can include fewer, other, or additional components in multiple configurations. In some examples, system 201 can be implemented in a single device. A person or persons using electronic devices 260/270, is optionally referred to herein as a user or users of the device(s). Attention is now directed towards exemplary concurrent displays of a three-dimensional environment on a first electronic device (e.g., corresponding to electronic device 260) and a second electronic device (e.g., corresponding to electronic device 270). As discussed below, the first electronic device may be in communication with the second electronic device in a multi-user communication session. In some examples, an avatar (e.g., a representation of) a user of the first electronic device may be displayed in the three-dimensional environment at the second electronic device, and an avatar of a user of the second electronic device may be displayed in the three-dimensional environment at the first electronic device. In some examples, the user of the first electronic device and the user of the second electronic device may be associated with a spatial group in the multi-user communication session.

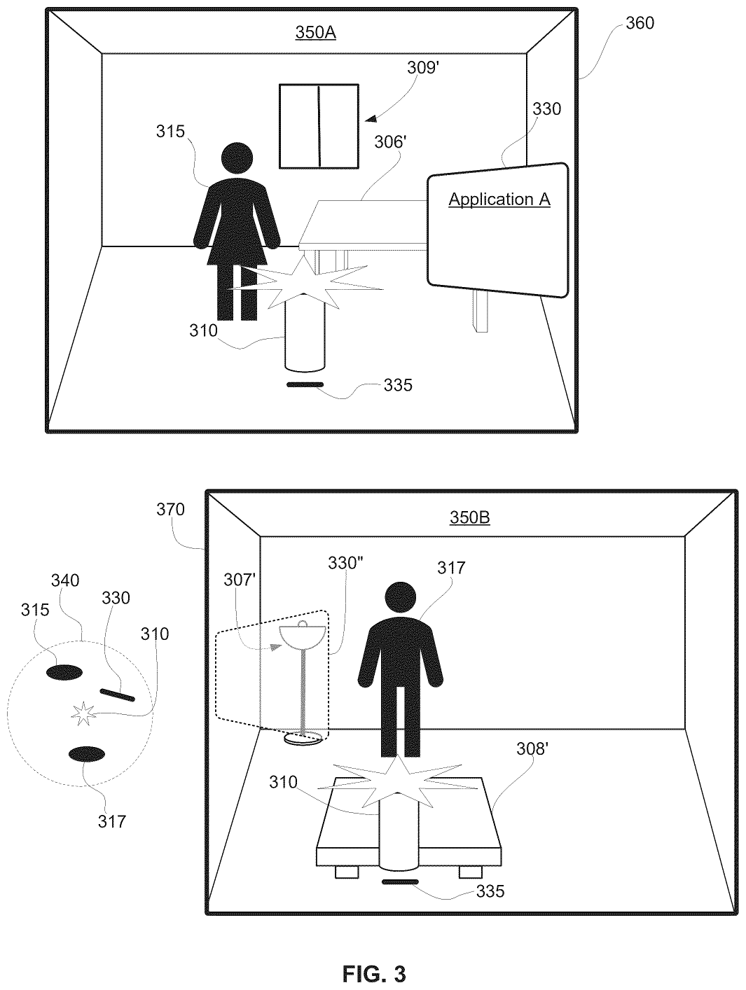

FIG. 3 illustrates an example of a spatial group 340 in a multi-user communication session that includes a first electronic device 360 and a second electronic device 370 according to some examples of the disclosure. In some examples, the first electronic device 360 may present a three-dimensional environment 350A, and the second electronic device 370 may present a three-dimensional environment 350B. The first electronic device 360 and the second electronic device 370 may be similar to electronic device 101 or 260/270, and/or may be a head mountable system/device and/or projection-based system/device (including a hologram-based system/device) configured to generate and present a three-dimensional environment, such as, for example, heads-up displays (HUDs), head mounted displays (HMDs), windows having integrated display capability, displays formed as lenses designed to be placed on a person's eyes (e.g., similar to contact lenses), respectively. In the example of FIG. 3, a first user is optionally wearing the first electronic device 360 and a second user is optionally wearing the second electronic device 370, such that the three-dimensional environment 350A/350B can be defined by X, Y and Z axes as viewed from a perspective of the electronic devices (e.g., a viewpoint associated with the electronic device 360/370, which may be a head-mounted display, for example).

As shown in FIG. 3, the first electronic device 360 may be in a first physical environment that includes a table 306 and a window 309. Thus, the three-dimensional environment 350A presented using the first electronic device 360 optionally includes captured portions of the physical environment surrounding the first electronic device 360, such as a representation of the table 306′ and a representation of the window 309′. Similarly, the second electronic device 370 may be in a second physical environment, different from the first physical environment (e.g., separate from the first physical environment), that includes a floor lamp 307 and a coffee table 308. Thus, the three-dimensional environment 350B presented using the second electronic device 370 optionally includes captured portions of the physical environment surrounding the second electronic device 370, such as a representation of the floor lamp 307′ and a representation of the coffee table 308′. Additionally, the three-dimensional environments 350A and 350B may include representations of the floor, ceiling, and walls of the room in which the first electronic device 360 and the second electronic device 370, respectively, are located.

As mentioned above, in some examples, the first electronic device 360 is optionally in a multi-user communication session with the second electronic device 370. For example, the first electronic device 360 and the second electronic device 370 (e.g., via communication circuitry 222A/222B) are configured to present a shared three-dimensional environment 350A/350B that includes one or more shared virtual objects (e.g., content such as images, video, audio and the like, representations of user interfaces of applications, etc.). As used herein, the term “shared three-dimensional environment” refers to a three-dimensional environment that is independently presented, displayed, and/or visible at two or more electronic devices via which content, applications, data, and the like may be shared and/or presented to users of the two or more electronic devices. In some examples, while the first electronic device 360 is in the multi-user communication session with the second electronic device 370, an avatar corresponding to the user of one electronic device is optionally displayed in the three-dimensional environment that is displayed via the other electronic device. For example, as shown in FIG. 3, at the first electronic device 360, an avatar 315 corresponding to the user of the second electronic device 370 is displayed in the three-dimensional environment 350A. Similarly, at the second electronic device 370, an avatar 317 corresponding to the user of the first electronic device 360 is displayed in the three-dimensional environment 350B.

In some examples, the presentation of avatars 315/317 as part of a shared three-dimensional environment is optionally accompanied by an audio effect corresponding to a voice of the users of the electronic devices 370/360. For example, the avatar 315 displayed in the three-dimensional environment 350A using the first electronic device 360 is optionally accompanied by an audio effect corresponding to the voice of the user of the second electronic device 370. In some such examples, when the user of the second electronic device 370 speaks, the voice of the user may be detected by the second electronic device 370 (e.g., via the microphone(s) 213B) and transmitted to the first electronic device 360 (e.g., via the communication circuitry 222B/222A), such that the detected voice of the user of the second electronic device 370 may be presented as audio (e.g., using speaker(s) 216A) to the user of the first electronic device 360 in three-dimensional environment 350A. In some examples, the audio effect corresponding to the voice of the user of the second electronic device 370 may be spatialized such that it appears to the user of the first electronic device 360 to emanate from the location of avatar 315 in the shared three-dimensional environment 350A (e.g., despite being outputted from the speakers of the first electronic device 360). Similarly, the avatar 317 displayed in the three-dimensional environment 350B using the second electronic device 370 is optionally accompanied by an audio effect corresponding to the voice of the user of the first electronic device 360. In some such examples, when the user of the first electronic device 360 speaks, the voice of the user may be detected by the first electronic device 360 (e.g., via the microphone(s) 213A) and transmitted to the second electronic device 370 (e.g., via the communication circuitry 222A/222B), such that the detected voice of the user of the first electronic device 360 may be presented as audio (e.g., using speaker(s) 216B) to the user of the second electronic device 370 in three-dimensional environment 350B. In some examples, the audio effect corresponding to the voice of the user of the first electronic device 360 may be spatialized such that it appears to the user of the second electronic device 370 to emanate from the location of avatar 317 in the shared three-dimensional environment 350B (e.g., despite being outputted from the speakers of the first electronic device 360).

In some examples, while in the multi-user communication session, the avatars 315/317 are displayed in the three-dimensional environments 350A/350B with respective orientations that correspond to and/or are based on orientations of the electronic devices 360/370 (and/or the users of electronic devices 360/370) in the physical environments surrounding the electronic devices 360/370. For example, as shown in FIG. 3, in the three-dimensional environment 350A, the avatar 315 is optionally facing toward the viewpoint of the user of the first electronic device 360, and in the three-dimensional environment 350B, the avatar 317 is optionally facing toward the viewpoint of the user of the second electronic device 370. As a particular user moves the electronic device (and/or themself) in the physical environment, the viewpoint of the user changes in accordance with the movement, which may thus also change an orientation of the user's avatar in the three-dimensional environment. For example, with reference to FIG. 3, if the user of the first electronic device 360 were to look leftward in the three-dimensional environment 350A such that the first electronic device 360 is rotated (e.g., a corresponding amount) to the left (e.g., counterclockwise), the user of the second electronic device 370 would see the avatar 317 corresponding to the user of the first electronic device 360 rotate to the right (e.g., clockwise) relative to the viewpoint of the user of the second electronic device 370 in accordance with the movement of the first electronic device 360.

Additionally, in some examples, while in the multi-user communication session, a viewpoint of the three-dimensional environments 350A/350B and/or a location of the viewpoint of the three-dimensional environments 350A/350B optionally changes in accordance with movement of the electronic devices 360/370 (e.g., by the users of the electronic devices 360/370). For example, while in the communication session, if the first electronic device 360 is moved closer toward the representation of the table 306′ and/or the avatar 315 (e.g., because the user of the first electronic device 360 moved forward in the physical environment surrounding the first electronic device 360), the viewpoint of the three-dimensional environment 350A would change accordingly, such that the representation of the table 306′, the representation of the window 309′ and the avatar 315 appear larger in the field of view. In some examples, each user may independently interact with the three-dimensional environment 350A/350B, such that changes in viewpoints of the three-dimensional environment 350A and/or interactions with virtual objects in the three-dimensional environment 350A by the first electronic device 360 optionally do not affect what is shown in the three-dimensional environment 350B at the second electronic device 370, and vice versa.

In some examples, the avatars 315/317 are a representation (e.g., a full-body rendering) of the users of the electronic devices 370/360. In some examples, the avatar 315/317 is a representation of a portion (e.g., a rendering of a head, face, head and torso, etc.) of the users of the electronic devices 370/360. In some examples, the avatars 315/317 are a user-personalized, user-selected, and/or user-created representation displayed in the three-dimensional environments 350A/350B that is representative of the users of the electronic devices 370/360. It should be understood that, while the avatars 315/317 illustrated in FIG. 3 correspond to full-body representations of the users of the electronic devices 370/360, respectively, alternative avatars may be provided, such as those described above.

As mentioned above, while the first electronic device 360 and the second electronic device 370 are in the multi-user communication session, the three-dimensional environments 350A/350B may be a shared three-dimensional environment that is presented using the electronic devices 360/370. In some examples, content that is viewed by one user at one electronic device may be shared with another user at another electronic device in the multi-user communication session. In some such examples, the content may be experienced (e.g., viewed and/or interacted with) by both users (e.g., via their respective electronic devices) in the shared three-dimensional environment. For example, as shown in FIG. 3, the three-dimensional environments 350A/350B include a shared virtual object 310 (e.g., which is optionally a three-dimensional virtual sculpture) that is viewable by and interactive to both users. As shown in FIG. 3, the shared virtual object 310 may be displayed with a grabber affordance (e.g., a handlebar) 335 that is selectable to initiate movement of the shared virtual object 310 within the three-dimensional environments 350A/350B.

In some examples, the three-dimensional environments 350A/350B include unshared content that is private to one user in the multi-user communication session. For example, in FIG. 3, the first electronic device 360 is displaying a private application window 330 in the three-dimensional environment 350A, which is optionally an object that is not shared between the first electronic device 360 and the second electronic device 370 in the multi-user communication session. In some examples, the private application window 330 may be associated with a respective application that is operating on the first electronic device 360 (e.g., such as a media player application, a web browsing application, a messaging application, etc.). Because the private application window 330 is not shared with the second electronic device 370, the second electronic device 370 optionally displays a representation of the private application window 330″ in three-dimensional environment 350B. As shown in FIG. 3, in some examples, the representation of the private application window 330″ may be a faded, occluded, discolored, and/or translucent representation of the private application window 330 that prevents the user of the second electronic device 370 from viewing contents of the private application window 330.

As mentioned previously above, in some examples, the user of the first electronic device 360 and the user of the second electronic device 370 are in a spatial group 340 within the multi-user communication session. In some examples, the spatial group 340 may be a baseline (e.g., a first or default) spatial group within the multi-user communication session. For example, when the user of the first electronic device 360 and the user of the second electronic device 370 initially join the multi-user communication session, the user of the first electronic device 360 and the user of the second electronic device 370 are automatically (and initially, as discussed in more detail below) associated with (e.g., grouped into) the spatial group 340 within the multi-user communication session. In some examples, while the users are in the spatial group 340 as shown in FIG. 3, the user of the first electronic device 360 and the user of the second electronic device 370 have a first spatial arrangement (e.g., first spatial template) within the shared three-dimensional environment. For example, the user of the first electronic device 360 and the user of the second electronic device 370, including objects that are displayed in the shared three-dimensional environment, have spatial truth within the spatial group 340. In some examples, spatial truth requires a consistent spatial arrangement between users (or representations thereof) and virtual objects. For example, a distance between the viewpoint of the user of the first electronic device 360 and the avatar 315 corresponding to the user of the second electronic device 370 may be the same as a distance between the viewpoint of the user of the second electronic device 370 and the avatar 317 corresponding to the user of the first electronic device 360. As described herein, if the location of the viewpoint of the user of the first electronic device 360 moves, the avatar 317 corresponding to the user of the first electronic device 360 moves in the three-dimensional environment 350B in accordance with the movement of the location of the viewpoint of the user relative to the viewpoint of the user of the second electronic device 370. Additionally, if the user of the first electronic device 360 performs an interaction on the shared virtual object 310 (e.g., moves the virtual object 310 in the three-dimensional environment 350A), the second electronic device 370 alters display of the shared virtual object 310 in the three-dimensional environment 350B in accordance with the interaction (e.g., moves the virtual object 310 in the three-dimensional environment 350B).

It should be understood that, in some examples, more than two electronic devices may be communicatively linked in a multi-user communication session. For example, in a situation in which three electronic devices are communicatively linked in a multi-user communication session, a first electronic device would display two avatars, rather than just one avatar, corresponding to the users of the other two electronic devices. It should therefore be understood that the various processes and exemplary interactions described herein with reference to the first electronic device 360 and the second electronic device 370 in the multi-user communication session optionally apply to situations in which more than two electronic devices are communicatively linked in a multi-user communication session.

In some examples, it may be advantageous to provide mechanisms for facilitating initiation of communication between users virtually in a three-dimensional environment based on user availability. For example, it may be desirable to provide a first user wishing to initiate communication (e.g., via a call) with a second user virtually in a three-dimensional environment with an indication of an availability of the second user prior to initiating the communication. Additionally, in some examples, it may be advantageous to enable the second user who is receiving the request to initiate communication with the first user to receive a visual indication of the request (e.g., a notification) without requiring the second user to be actively using (e.g., wearing) a head-mounted device associated with the second user. In some examples, as described herein, establishing communication between users virtually in a three-dimensional environment includes displaying visual representations (e.g., three-dimensional avatars or two-dimensional user interfaces) corresponding to the users in the three-dimensional environment (e.g., via the users' respective electronic devices). In some examples, as discussed below, replying to the request to initiate communication with a respective user virtually in a three-dimensional environment is based on an “opt out” mode of reply via the electronic device associated with the user receiving the request.

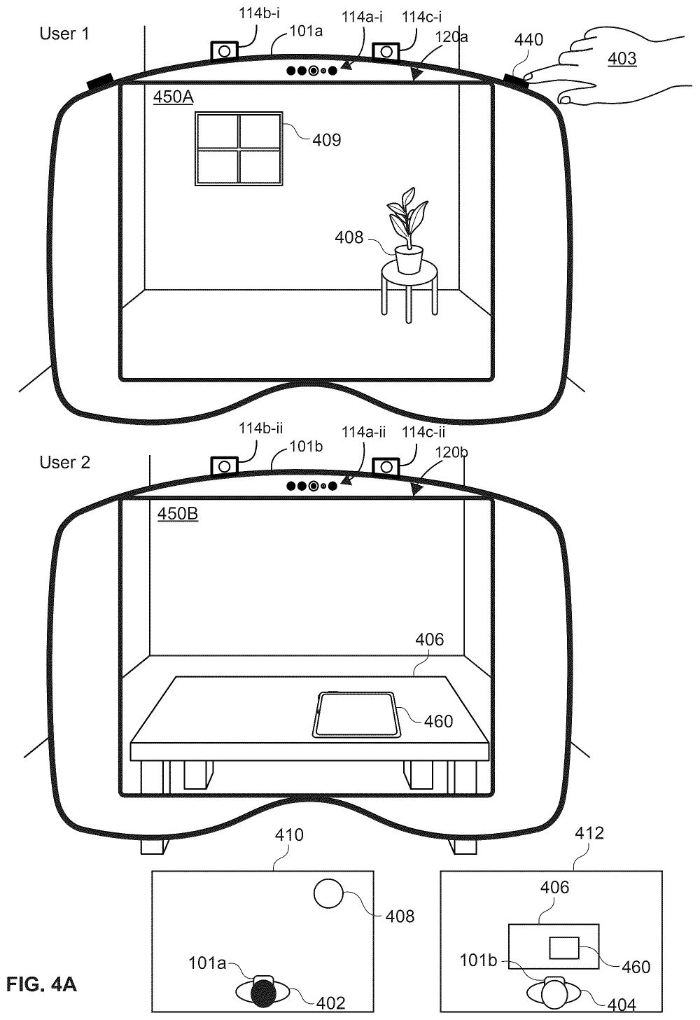

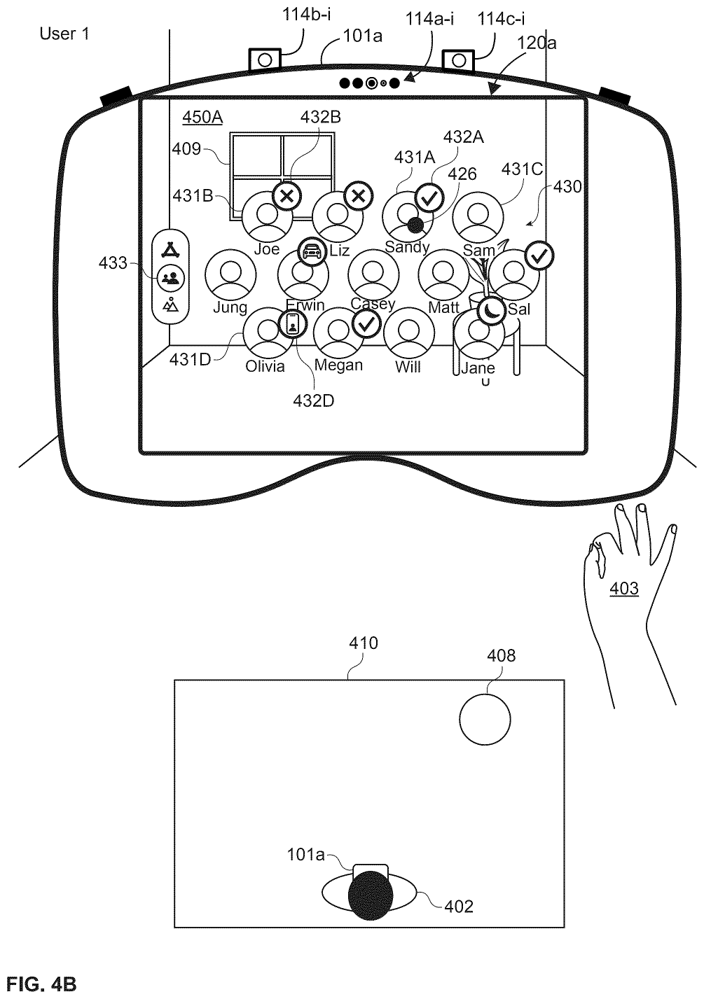

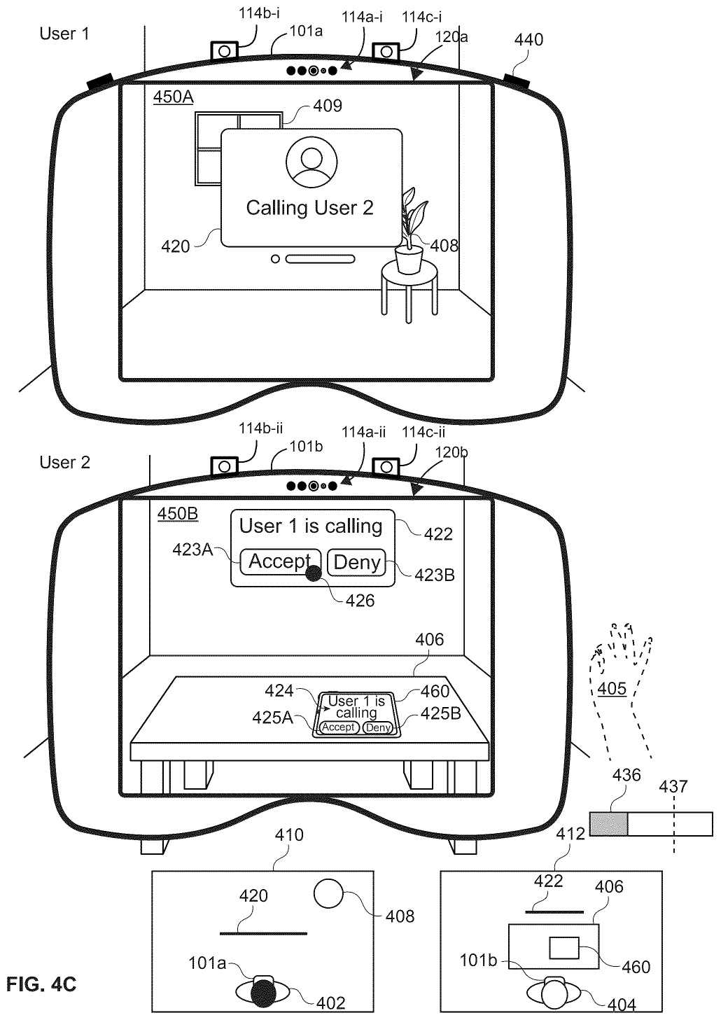

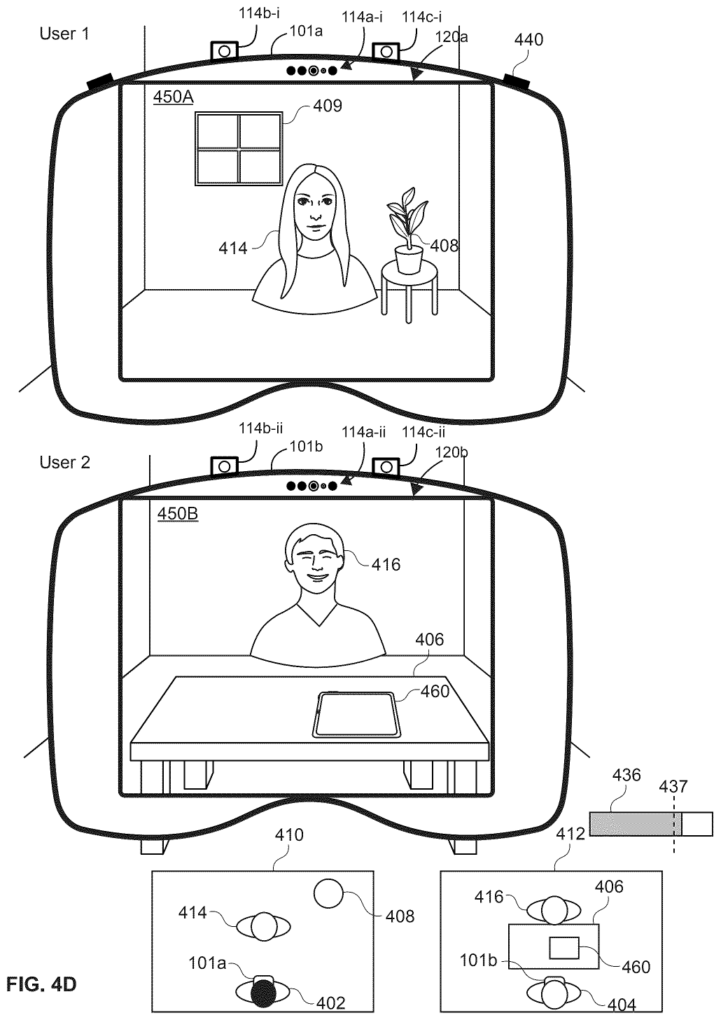

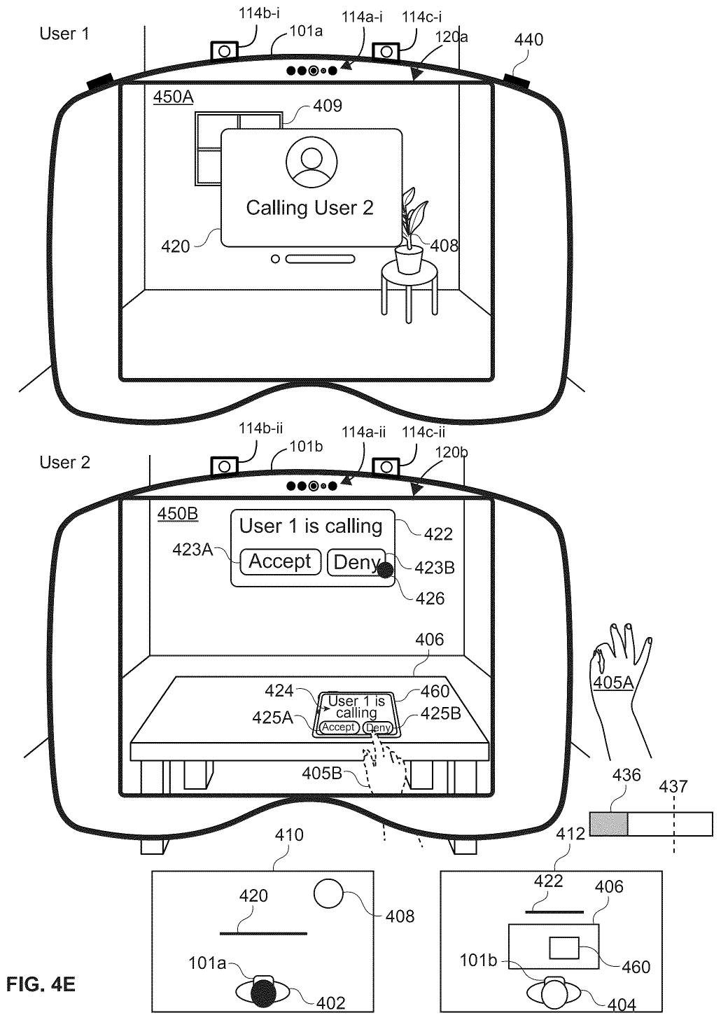

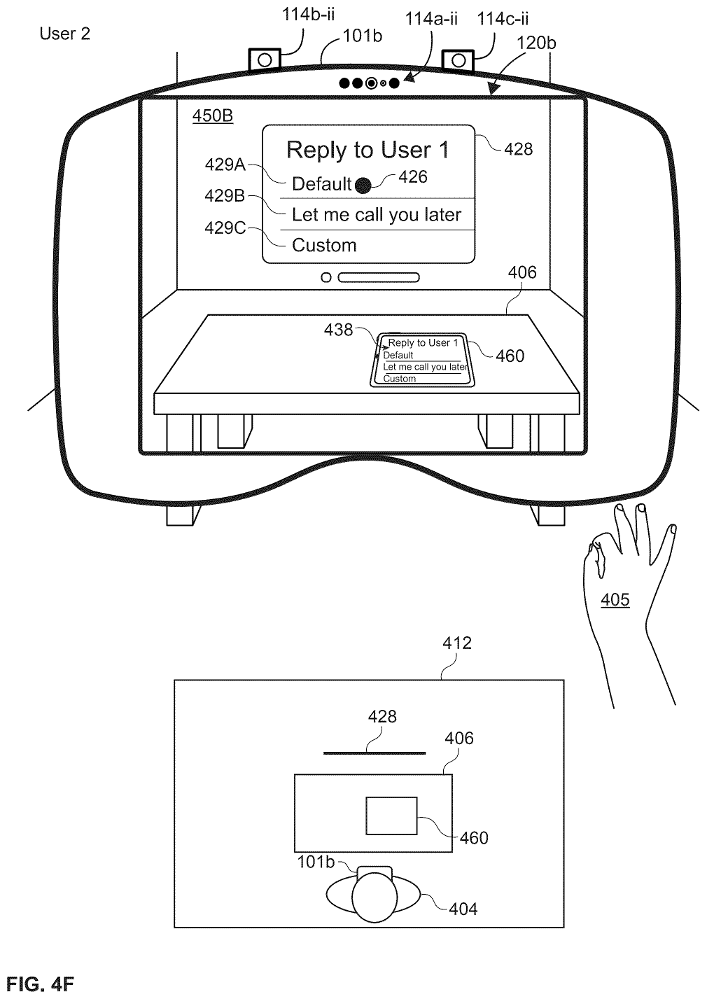

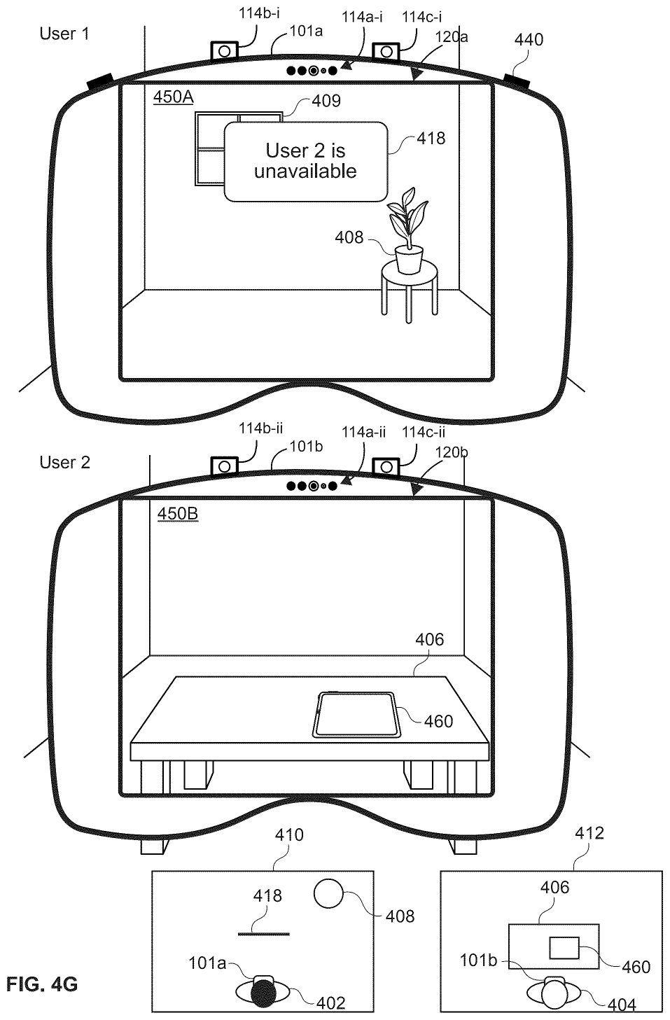

FIGS. 4A-4G illustrate examples of facilitating transmitting a request to initiate communication between users virtually in a three-dimensional environment according to some examples of the disclosure. In some examples, a first electronic device 101a may present, via display 120a, a three-dimensional environment 450A, and a second electronic device 101b may present, via display 120b, a three-dimensional environment 450B. The first electronic device 101a and the second electronic device 101b may be similar to electronic device 101 or electronic devices 260/270, and/or may be a head mountable system/device and/or projection-based system/device (including a hologram-based system/device) configured to generate and present a three-dimensional environment, such as, for example, heads-up displays (HUDs), head mounted displays (HMDs), windows having integrated display capability, or displays formed as lenses designed to be placed on a person's eyes (e.g., similar to contact lenses), respectively. In some examples, the first electronic device 101a is configured to communicate with the second electronic device 101b. In the example of FIGS. 4A-4G, a first user 402 is optionally wearing the first electronic device 101a, as shown in top-down view 410, and a second user 404 is optionally wearing the second electronic device 101b, as shown in top-down view 412, such that the three-dimensional environments 450A/450B can be defined by X, Y and Z axes as viewed from a perspective of the electronic devices (e.g., a viewpoint associated with the users of the electronic devices 101a/101b).

As shown in FIG. 4A, the first electronic device 101a may be in a first physical environment that includes a window 409 and a houseplant 408. Thus, the three-dimensional environment 450A presented using the first electronic device 101a optionally includes captured portions (e.g., captured via external image sensors 114b-i and 114c-i) of the first physical environment surrounding the first electronic device 101a, such as representations of the window 409 and the houseplant 408. Similarly, the second electronic device 101b may be in a second physical environment, different from the first physical environment (e.g., separate from the first physical environment), that includes a table 406 and mobile electronic device 460 (e.g., a smart phone, tablet, laptop, etc.). Thus, the three-dimensional environment 450B presented using the second electronic device 101b optionally includes captured portions (e.g., captured via external image sensors 114b-ii and 114c-ii) of the second physical environment surrounding the second electronic device 101b, such as a representation of the table 406 and a representation of the mobile electronic device 460. Additionally, the three-dimensional environments 450A and 450B may include representations of the floor, ceiling, and walls of the room in which the first electronic device 101a and the second electronic device 101b are located, respectively. In some examples, the mobile electronic device 460 is in communication with the second electronic device 101b.

In some examples, the electronic device 101a/101b are configured to initiate communication with respective users in the three-dimensional environments 450A/450B based on user availability. In FIG. 4A, the first electronic device 101a detects an input corresponding to a request to display a user interface via which to initiate communication with a respective user based on user availability in the three-dimensional environment 450A. For example, as shown in FIG. 4A, the first electronic device 101a detects a press of hardware element 440 (e.g., a physical button of the first electronic device 101a) provided by hand 403 of the first user 402.

In some examples, as shown in FIG. 4B, in response to detecting the selection of the hardware element 440, the first electronic device 101a displays people picker user interface 430 in the three-dimensional environment 450A. In some examples, the people picker user interface 430 is associated with a home user interface of the first electronic device 101a. For example, as indicated in FIG. 4B, the people picker user interface 430 corresponds to tab 433 of a dashboard associated with the home user interface of the first electronic device 101a. In some examples, other tabs of the dashboard associated with the home user interface enable the first user 402 to launch applications at the first electronic device 101a and/or to display virtual environments within the three-dimensional environment 450A. In some examples, as shown in FIG. 4B, the people picker user interface 430 enables the first user 402 to initiate communication with a respective user. For example, as shown in FIG. 4B, the people picker user interface 430 includes a plurality of representations of a plurality of users with which the first electronic device 101a is configured to initiate communication in the three-dimensional environment 450A. As shown in FIG. 4B, the plurality of representations of the people picker user interface 430 optionally includes first representation 431A associated with a first user (e.g., Sandy, corresponding to the second user 404 in FIG. 4A), second representation 431B associated with a second user (e.g., Joc), third representation 431C associated with a third user (e.g., Sam), and a fourth representation 431D associated with a fourth user (e.g., Olivia). In some examples, as shown in FIG. 4B, the plurality of representations includes visual representations of the users with which the representations are associated. For example, in FIG. 4B, the plurality of representations includes images, photographs, icons, avatars, sketches, and/or other visual representations of the plurality of users. In some examples, the plurality of users included in the people picker user interface 430 corresponds to users belonging to a list of contacts stored at the first electronic device 101a. In some examples, the plurality of users included in the people picker user interface 430 corresponds to users suggested to the first user 402, such as based on prior user activity (e.g., prior user communication), proximity to those users, receipt of notifications from those users, etc.

In some examples, the plurality of representations of the plurality of users in the people picker user interface 430 is displayed with visual indications of a current status (e.g., availability) of the plurality of users. In some examples, respective users satisfying one or more first criteria include a visual indication of a first type that indicates the respective users are currently available (e.g., are free or are otherwise not currently occupied at their respective electronic devices) to receive a communication request from the first user 402 (e.g., via the first electronic device 101a). For example, as shown in FIG. 4B, the first representation 431A associated with the user Sandy is displayed with visual indication 432A (e.g., a checkmark icon) that provides a visual indication that the user Sandy is currently available for communication. Additionally, as shown in FIG. 4B, the representations of users Sal and Megan in the people picker user interface 430 are displayed with the visual indication of the first type (e.g., the checkmark icon) that provides a visual indication that the users Sal and Megan are available for communication, and therefore satisfy the one or more first criteria. Additionally or alternatively, in some examples, the visual indication of the first type includes display of the corresponding representation with a particular visual appearance (e.g., a first visual appearance). For example, in FIG. 4B, the first representation 431A that is associated with the user Sandy may be displayed with a particular color, brightness level, transparency level, saturation, and/or shadow to visually indicate that the user Sandy is available for communication, optionally without displaying any visual indications, such as the representations of the users Matt and Will in the people picker user interface 430.

In some examples, respective users that do not satisfy the one or more first criteria include a visual indication of a second type, different from the first type, that indicates the respective users are not currently available (e.g., are currently occupied at their respective electronic devices) to receive a communication request from the first user 402 (e.g., via the first electronic device 101a). For example, as shown in FIG. 4B, the second representation 431B associated with the user Joe is displayed with visual indication 432B (e.g., an X icon) that provides a visual indication that the user Joe is currently not available for communication. Additionally, as shown in FIG. 4B, the representation of the user Liz in the people picker user interface 430 is displayed with the visual indication of the second type (e.g., the X icon) that provides a visual indication that the user Liz is currently not available for communication, and therefore does not satisfy the one or more first criteria. Additionally or alternatively, in some examples, the visual indication of the second type includes display of the corresponding representation with a particular visual appearance (e.g., a second visual appearance). For example, in FIG. 4B, the second representation 431B that is associated with the user Joe may be displayed with a particular color, brightness level, transparency level, saturation, and/or shadow to visually indicate that the user Joe is not available for communication, optionally without displaying any visual indications, such as the representations of the users Jung and Casey in the people picker user interface 430. It should be understood that, though the representation of a particular user may indicate that the user is unavailable for communication, such as the second representation 431B of the user Joe, the first user 402 may still initiate communication with that user, though a denial of the request to enter communication is likely.

In some examples, a respective user of the plurality of users is determined to be available for communication (e.g., is determined to satisfy the one or more first criteria) in accordance with a determination that a respective electronic device associated with the respective user is powered on. For example, the respective user is actively using (e.g., wearing) the respective electronic device. In some examples, a respective user of the plurality of users is determined to be available for communication in accordance with a determination that a respective electronic device associated with the respective user is in a field of view of one or more cameras of the respective electronic device, such as internal or external image sensors (e.g., 114a-114c) of the respective electronic device. In some examples, a respective user of the plurality of users is determined to be available for communication in accordance with a determination that the respective user is within a threshold distance of the respective electronic device. For example, proximity between the respective user and the respective electronic device may be determined based on a distance between the respective user and one or more cameras or other sensors of the respective electronic device, and/or based on a distance between the respective electronic device and a mobile electronic device in communication with the respective electronic device, such as a distance between and/or a strength of a signal shared between the respective electronic device and a smart phone, smart watch, tablet, and/or laptop associated with the respective user. As discussed in more detail herein later, the determination that a respective user is currently available for communication may not require that the respective electronic device is currently being worn by (e.g., on a head of) the respective user.

In some examples, the plurality of the representations of the plurality of users includes a visual indication of a current state or activity of the respective electronic devices associated with the plurality of users, optionally in addition to or in lieu of displaying the visual indications of the first type and/or the second type discussed above. For example, as shown in FIG. 4B, the fourth representation 431D of the user Olivia includes visual indication 432D that indicates a current focus mode (e.g., a respective mode that controls provision of notifications) of the electronic device associated with the user Olivia, such as a work focus mode (e.g., the user Olivia is currently at a work location and/or is actively working) that is akin to a quiet hours mode at the electronic device associated with the user Olivia. In some examples, a particular focus mode is activated automatically at the electronic device (e.g., in response to detecting that the user is in a particular location specified by the user and/or is interacting with a particular application on the electronic device that causes the focus mode to be activated) or is activated at the electronic device in response to detecting user input for activating the focus mode. As another example, the representation of the user Erwin is displayed with a visual indication of a driving/traveling focus mode (e.g., the electronic device associated with Erwin is currently in motion, optionally above a predefined threshold (e.g., 1, 2, 5, 10, 15, 20, 30, etc. m/s) and the representation of the user Jane is displayed with a visual indication of a do not disturb focus mode (e.g., the electronic device associated with Jane is set to silence incoming notifications). As alluded to above, in some examples, the particular focus mode that is activated at an electronic device controls whether notifications are silenced and/or whether exceptions are applied. For example, a respective user may configure a particular focus mode to generate notifications for notification events associated with certain contacts (e.g., favorite contacts) and/or applications (e.g., user-selected applications), while silencing all others. In the people picker user interface 430 of FIG. 4B, the visual indications of the focus modes that are active at the indicated electronic devices provide an indication that the user associated with a particular electronic device is currently engaged in a certain type of activity (e.g., work or driving), without providing an indication of the specific applications and/or content with which the user is interacting, thereby conserving user privacy while providing an indication of user availability. It should be understood that the visual indications of the focus modes do not necessarily indicate that the corresponding users are available or unavailable to receive communication requests, but provide an indication that the users are otherwise currently occupied, which helps inform the user's decision of whether to initiate communication with the user. Accordingly, in some examples, the display of the visual indications of the focus modes is optionally independent of the one or more first criteria involving user availability discussed above. Alternatively, in some examples, the display of the visual indications of the focus modes is in accordance with a determination that one or more first criteria are not satisfied. For example, a focus mode being active at a particular electronic device associated with a user is determined by the first electronic device 101a to be an indication that the user is engaging in an activity and is therefore not currently available for communication, which causes the first electronic device 101a to display the representation of the user with a visual indication of the focus mode, rather than the visual indication of the first type (e.g., the checkmark icon) discussed above.

In some examples, the determination of whether a particular user satisfies the one or more first criteria is based on data including an indication of status/availability that is shared with the first electronic device 101a. For example, the electronic devices associated with the plurality of users represented in the people picker user interface 430 transmit data to the first electronic device 101a that provides an indication of a current status (e.g., focus mode status and/or availability) of the plurality of users. In FIG. 4B, as an example, the electronic device associated with the user Joe transmits data to the first electronic device 101a that indicates user Joc is currently unavailable for communication with the first user 402, which causes the first electronic device 101a to display the second representation 431B with the visual indication 432B when the people picker user interface 430 is displayed in the three-dimensional environment 450A. Similarly, in some examples, as shown in FIG. 4B, the electronic device (e.g., the second electronic device 101b in FIG. 4A above) associated with the user Sandy (e.g., corresponding to the second user 404 in FIG. 4A above) transmits data to the first electronic device 101a that indicates user Sandy is currently available for communication with the first user 402, which causes the first electronic device 101a to display the first representation 431A with the visual indication 432A. In some examples, the first electronic device 101a receives the data discussed above from the electronic devices periodically (e.g., over preset or regular time intervals, such as every 5, 10, 15, 30, 60, 90, 120, 180, 300, etc. seconds). In some examples, the first electronic device 101a receives the data discussed above from the electronic devices in accordance with a change and/or update in a status and/or availability of the users associated with the electronic devices. For example, a respective electronic device transmits updated data to the first electronic device 101a that indicates a focus mode at the respective electronic device has been deactivated or activated (e.g., by the user associated with the respective electronic device), the respective electronic device is now in use or is no longer in use, etc.

In FIG. 4B, the first electronic device 101a detects an input corresponding to a request to initiate communication with the second user 404 of the second electronic device 101b. For example, as shown in FIG. 4B, the first electronic device 101a detects a selection of the first representation 431A of the plurality of representations in the people picker user interface 430. In some examples, the selection is provided via an air pinch gesture performed by the hand 403 of the first user 402, optionally while gaze 426 of the first user 402 is directed to the first representation 431A in the three-dimensional environment 450A.

In some examples, as shown in FIG. 4C, in response to detecting the selection of the first representation 431A, the first electronic device 101a initiates communication with the second user 404 at the second electronic device 101b. For example, as indicated in FIG. 4C, the first electronic device 101a initiates a call with the second electronic device 101b. In some examples, as shown in FIG. 4C, initiating communication with the second user 404 includes displaying user interface object 420 in the three-dimensional environment 450A that indicates to the first user 402 that the communication has been initiated. In some examples, when the communication is initiated, the second electronic device 101b receives an indication of a request to enter communication with the first user 402 at the first electronic device 101a. For example, as shown in FIG. 4C, the second electronic device 101b displays user interface object 422 (e.g., a notification) corresponding to the incoming request in the three-dimensional environment 450B. In some examples, as shown in FIG. 4C, the user interface object 422 includes first option 423A that is selectable to accept the incoming request and a second option 423B that is selectable to deny the incoming request.

In some examples, when the second electronic device 101b displays the user interface object 422 in the three-dimensional environment 450B, the mobile electronic device 460 displays notification 424 (e.g., via a display of the mobile electronic device 460, such as a touchscreen of the mobile electronic device 460). In some examples, the notification 424 corresponds to the user interface object 422 displayed at the second electronic device 101b. For example, as shown in FIG. 4C, the notification 424 includes first option 425A that is selectable to accept the incoming request to enter communication with the first electronic device 101a and second option 425B that is selectable to deny the incoming request. In some examples, the mobile electronic device 460 displays the notification 424 because the mobile electronic device 460 is in communication with the second electronic device 101b (e.g., the mobile electronic device 460 receives a signal or other instruction from the second electronic device 101b to display the notification 424). In some examples, the mobile electronic device 460 displays the notification 424 because the mobile electronic device 460 and the second electronic device 101b are associated with a same user account of the second user 404. For example, the second user 404 is signed into the same user account on the second electronic device 101b and the mobile electronic device 460, thereby causing the mobile electronic device 460 to receive the same or similar request from the first electronic device 101a as the second electronic device 101b.

In some examples, as shown in FIG. 4C, the second electronic device 101b detects an indication accepting the request from the first electronic device 101a to enter communication with the first user 402 at the first electronic device 101a. For example, as shown in FIG. 4C, the second electronic device 101b detects a selection of the first option 423A of the user interface object 422, such as via an air pinch gesture performed by the hand 403 while the gaze 426 is directed to the first option 423A. Alternatively, in some examples, detecting the indication of accepting the request form the first electronic device 101a includes determining that a threshold amount of time (e.g., 1, 2, 3, 4, 5, 8, 10, etc. seconds) elapses since displaying the user interface object 422 in the three-dimensional environment 450B, without receiving user input denying the request (e.g., via a selection of the second option 423B). For example, from FIGS. 4C to 4D, as indicated in time bar 436, the second electronic device 101b determines that time 437 elapses since the display of the user interface object 422 in the three-dimensional environment 450B.

In some examples, as shown in FIG. 4D, in response to detecting the indication of acceptance of the request from the first electronic device 101a to enter communication with the first user 402 at the first electronic device 101a, the first electronic device 101a and the second electronic device 101b enter a communication session (e.g., a multi-user communication session as discussed above with reference to FIG. 3). For example, as shown in FIG. 4D, the first electronic device 101a displays avatar 414 corresponding to the second user 404 in the three-dimensional environment 450A and the second electronic device 101b displays avatar 416 corresponding to the first user 402 in the three-dimensional environment 450B. In some examples, the avatars 414/416 have one or more characteristics of the avatars 315/317 described above with reference to FIG. 3.

FIG. 4E illustrates an alternative example of the second user 404 denying the request to enter communication with the first user 402. For example, as shown in FIG. 4E, while the second electronic device 101b is displaying the user interface object 422 in the three-dimensional environment 450B that includes the first option 423A and the second option 423B, the second electronic device 101b detects selection of the second option 423B. As shown in FIG. 4E, the second electronic device 101b optionally detects an air pinch gesture performed by hand 405A of the second user 404, while gaze 426 of the second user 404 is directed to the second option 423B, prior to the threshold amount of time 437 elapsing since the display of the user interface object 422 in the three-dimensional environment 450B. Alternatively, in some examples, as shown in FIG. 4E, the mobile electronic device 460 detects selection of the second option 425B of the notification 424 displayed on the mobile electronic device 460. For example, as shown in FIG. 4E, the mobile electronic device 460 detects a tap of a contact directed to the second option 425B displayed on the touchscreen of the mobile electronic device 460, prior to the threshold amount of time 437 elapsing since the display of the notification 424 on the mobile electronic device 460.

In some examples, as shown in FIG. 4F, in response to detecting the indication of the denial of the request to enter communication with the first user 402, the second electronic device 101b displays user interface 428 in the three-dimensional environment 450B that includes options for transmitting a response to the first user 402, without entering the communication session with the first electronic device 101a. For example, as shown in FIG. 4F, the user interface 428 includes first option 429A that is selectable to transmit a default response to the first user 402 (e.g., formulated by the second electronic device 101b), second option 429B that is selectable to transmit a message to the first user (e.g., “Let me call you later”), and third option 429C that is selectable to transmit a custom reply to the first user 402 (e.g., a user-selected message). In some examples, as shown in FIG. 4F, the mobile electronic device 460 displays user interface 438 corresponding to the user interface 428 that includes the same or similar reply options.

In FIG. 4F, the second electronic device 101b detects a selection of the first option 429A in the user interface 428 in the three-dimensional environment 450B. For example, as shown in FIG. 4F, the second electronic device 101b detects an air pinch gesture performed by the hand 405 of the second user 404, optionally while the gaze 426 of the second user 404 is directed to the first option 429A in the three-dimensional environment 450B. In some examples, in response to detecting the selection of the first option 429A, the second electronic device 101b transmits a reply to the first electronic device 101a in accordance with the first option 429A. For example, as shown in FIG. 4G, when the second electronic device 101b transmits the reply to the first electronic device 101a, the first electronic device 101a displays message element 418 in the three-dimensional environment 450A that includes the default reply selected by the second user 404 (e.g., “User 2 is unavailable”). Additionally, as mentioned above, the second electronic device 101b forgoes entering the communication session with the first electronic device 101a. For example, as shown in FIG. 4G, the first electronic device 101a forgoes displaying an avatar (e.g., avatar 414) corresponding to the second user 404 and the second electronic device 101b forgoes displaying an avatar (e.g., avatar 416) corresponding to the first user 402.

Attention is now directed toward examples of facilitating initiation of communication between users in a three-dimensional environment while one of the users is not actively wearing their electronic device.

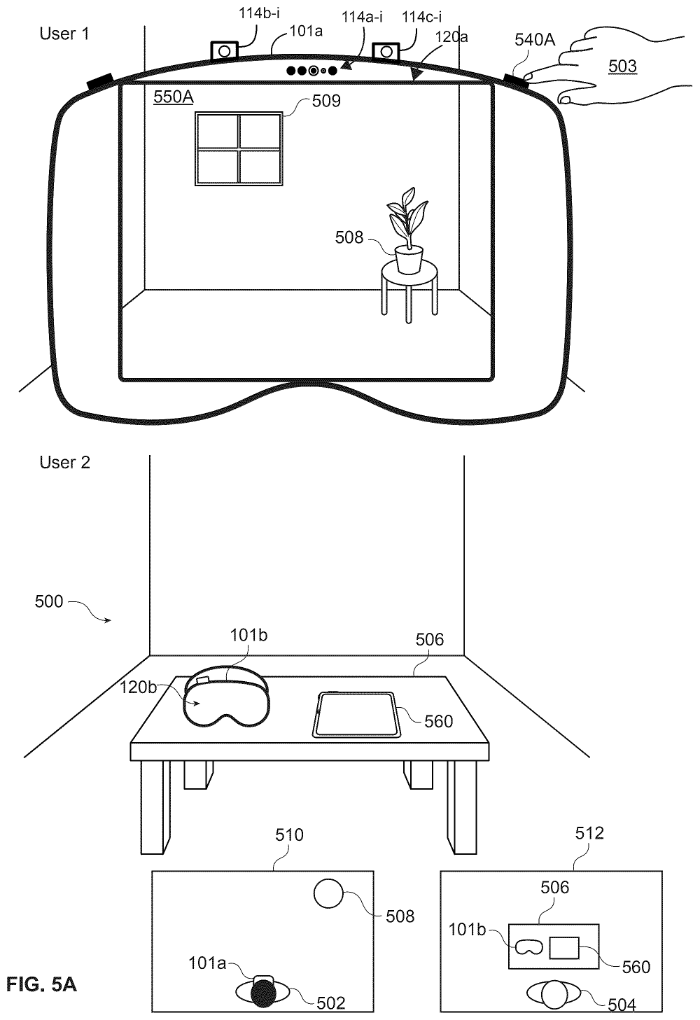

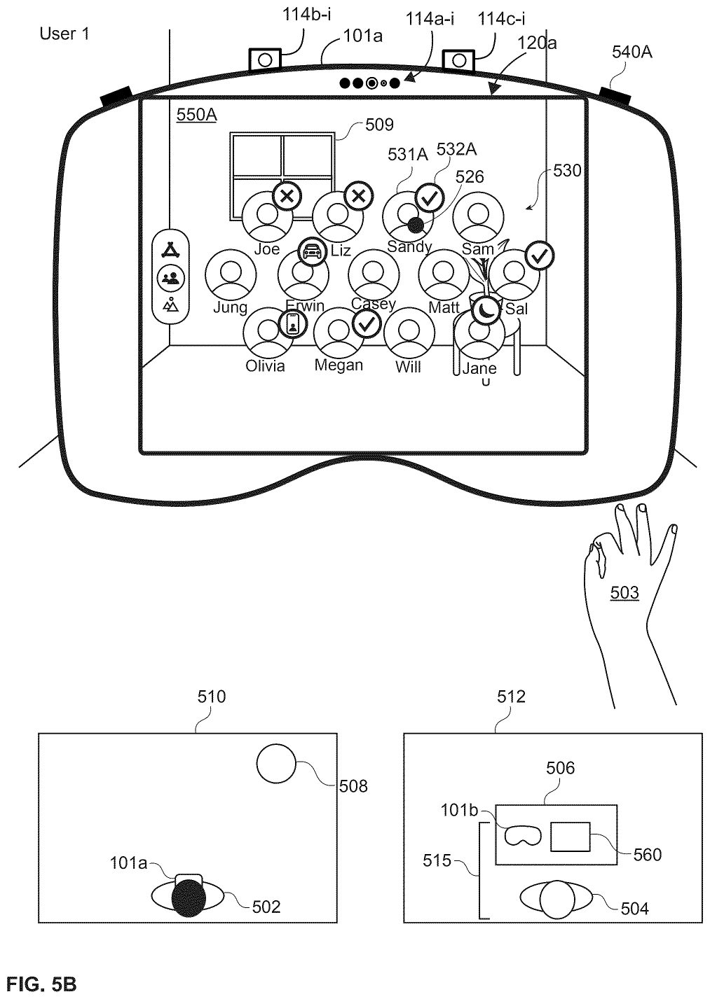

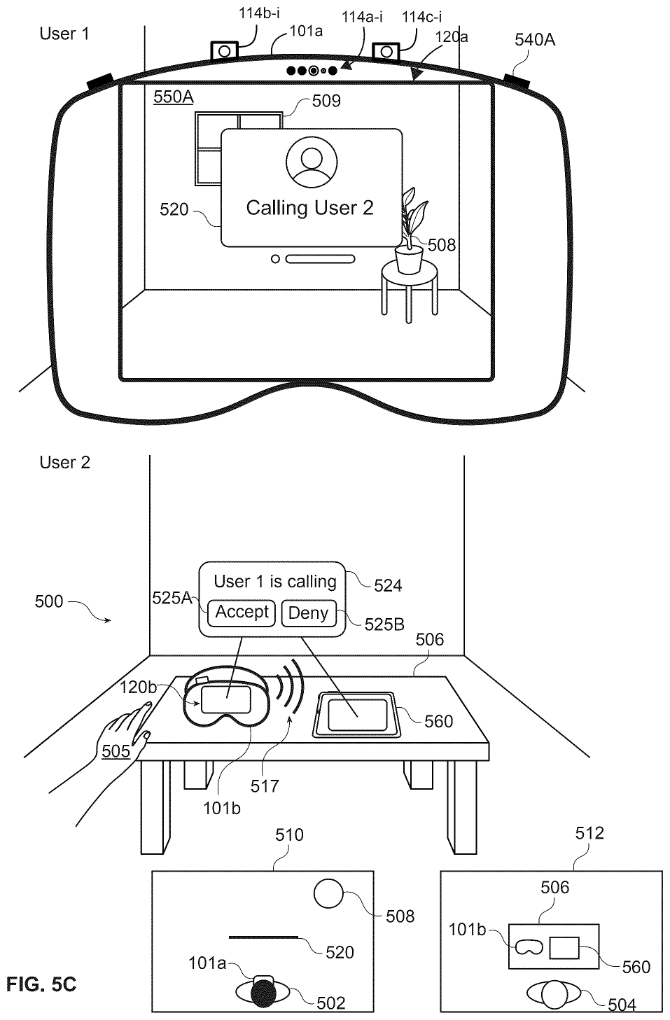

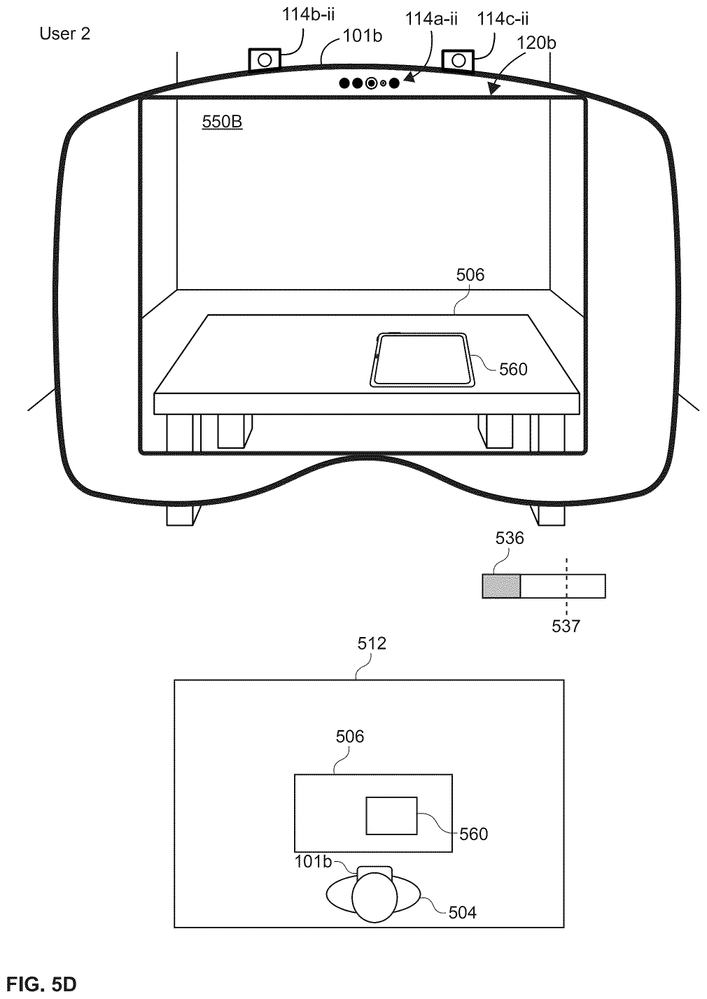

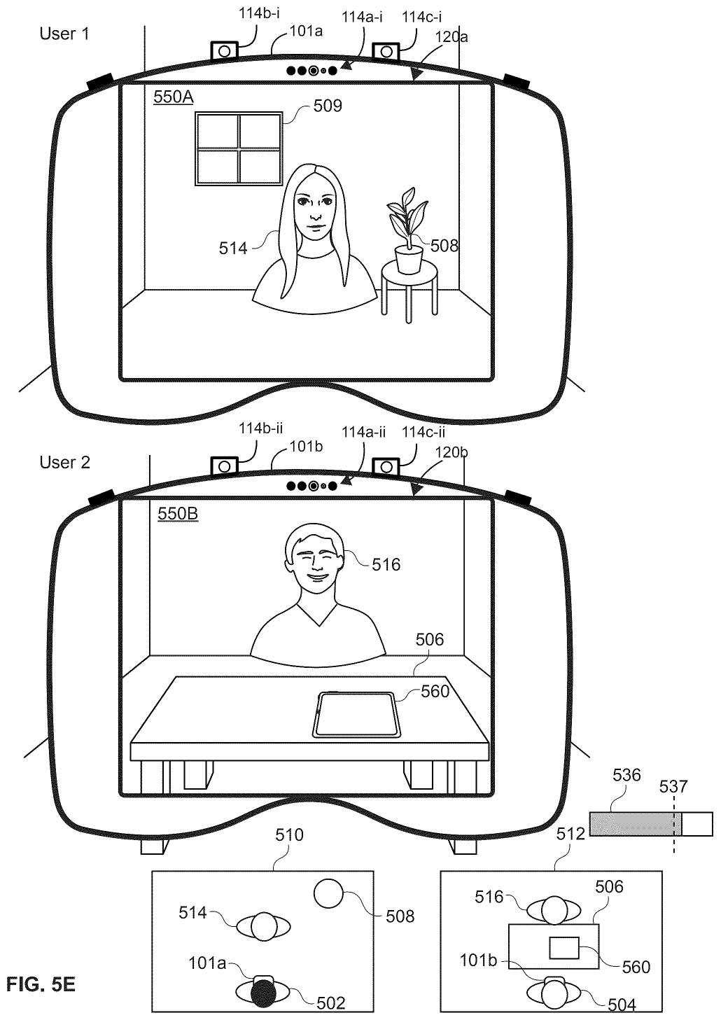

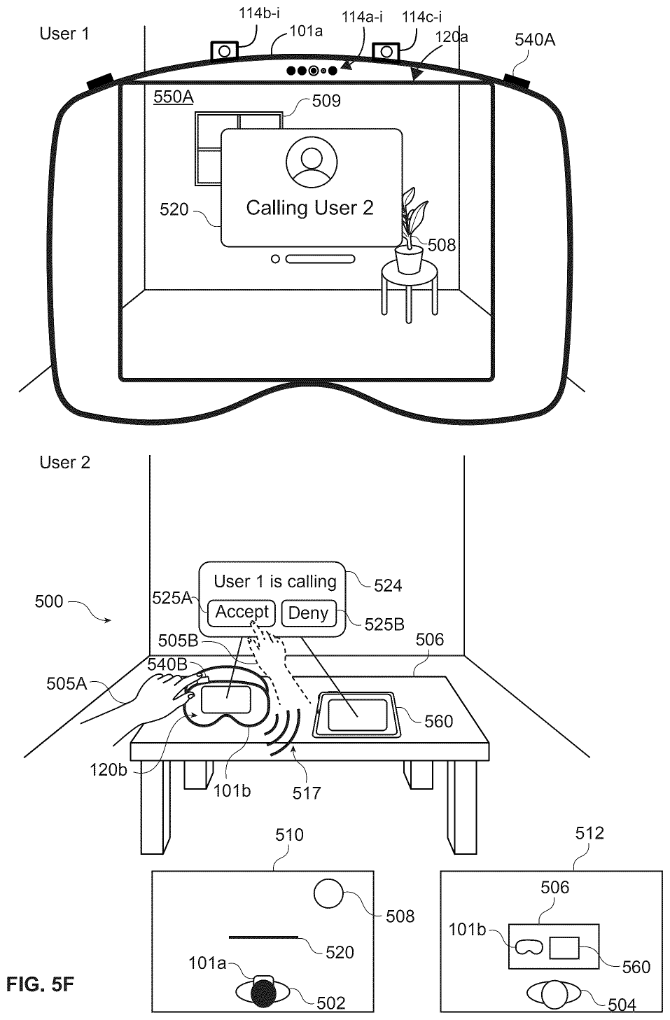

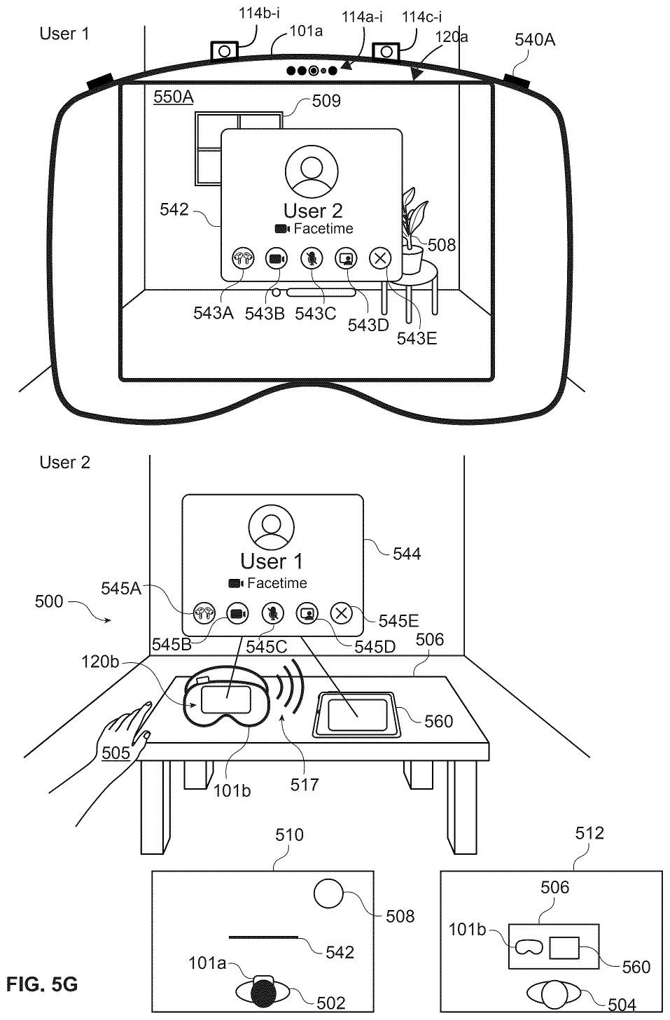

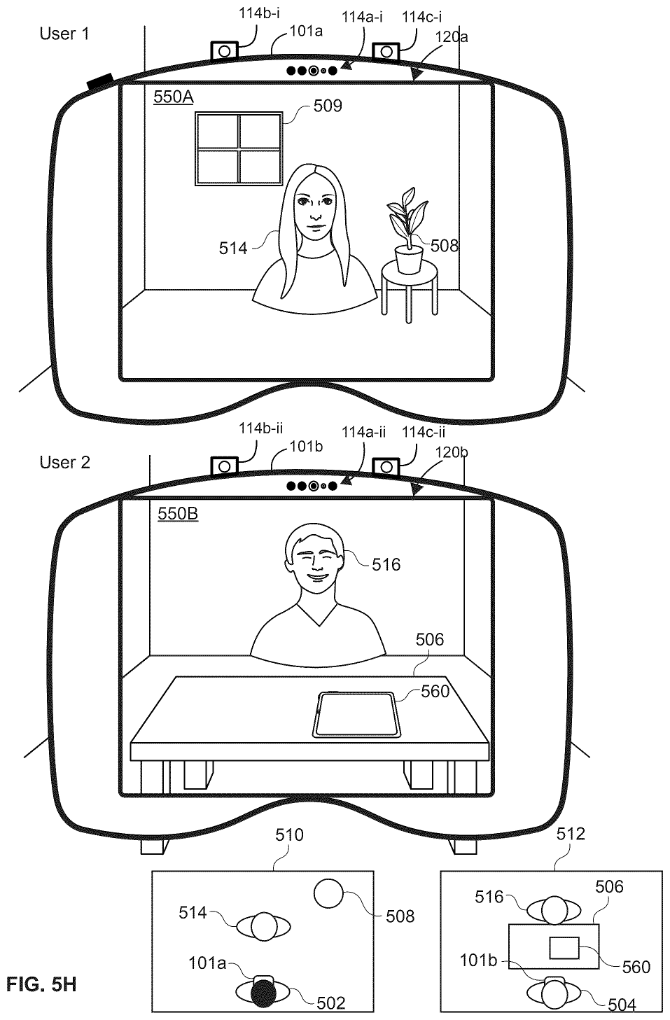

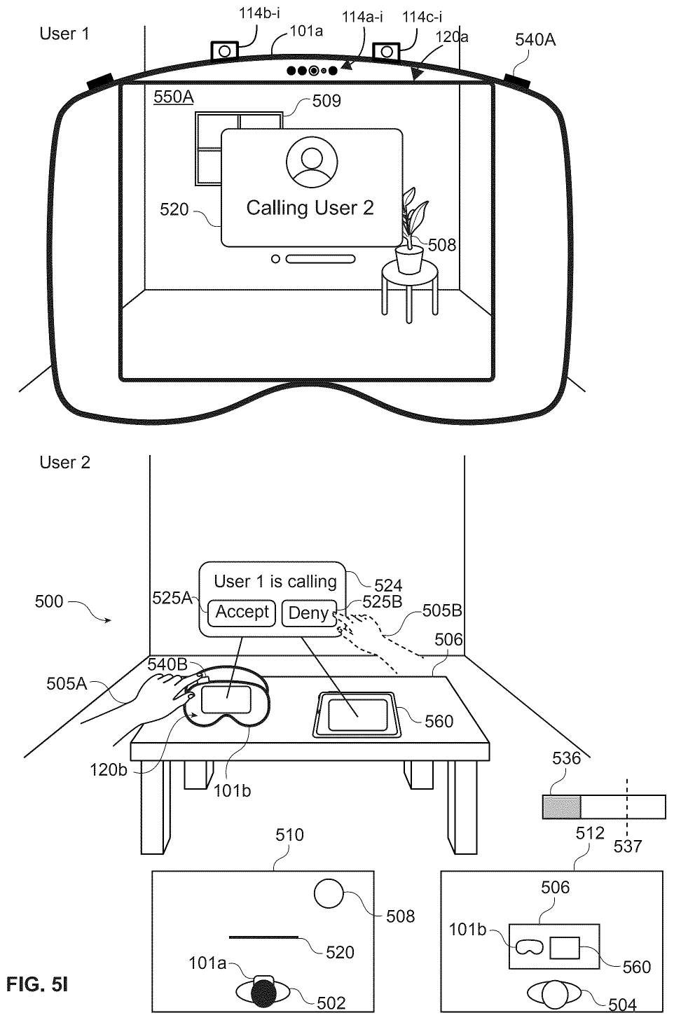

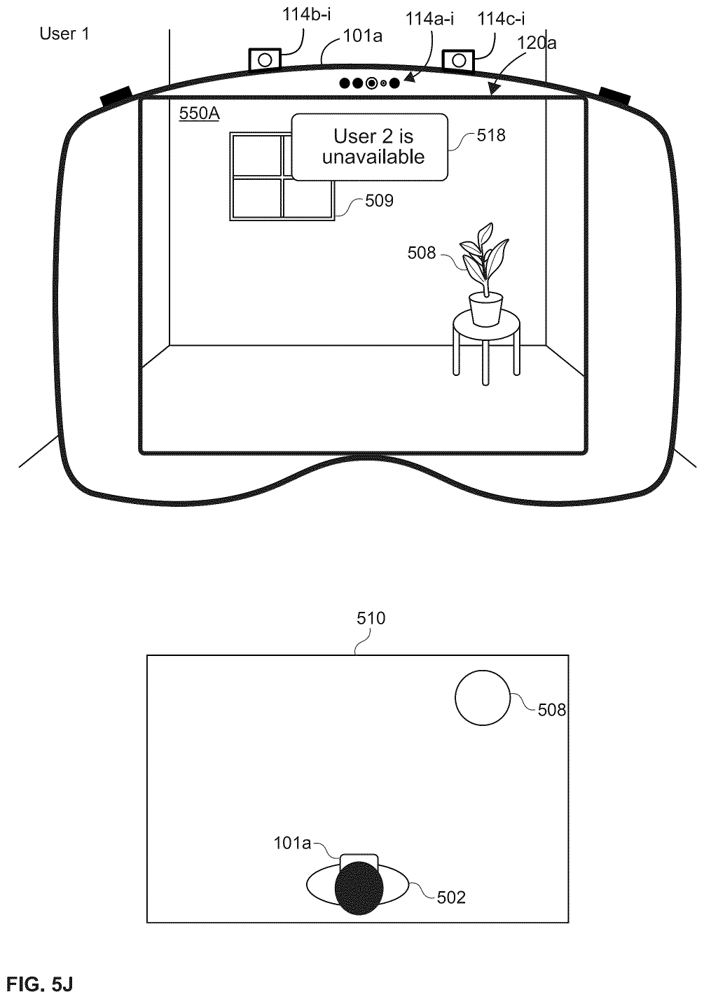

FIGS. 5A-5J illustrate examples of facilitating communication between users virtually in a three-dimensional environment according to some examples of the disclosure. In some examples, the first user 502 and the second user 504 correspond to first user 402 and second user 404, respectively, of FIGS. 4A-4G.

As shown in FIG. 5A, the first electronic device 101a is presenting (e.g., via display 120a) three-dimensional environment 550A. In FIG. 5A, as similarly discussed above, the three-dimensional environment 550A includes representations (e.g., passthrough representations or computer-generated representations) of a first physical environment of the first electronic device 101a. For example, as shown in overhead view 510 in FIG. 5A, the first physical environment includes houseplant 508 and window 509. Accordingly, as shown in FIG. 5A, the three-dimensional environment 550A presented using the first electronic device 101a includes representations of the houseplant 508 and the window 509 (e.g., the houseplant 508 and the window 509 are visible in a field of view of the first electronic device 101a). In some examples, the three-dimensional environment 550A has one or more characteristics of three-dimensional environment 450A discussed above.

Additionally, in some examples, as shown in FIG. 5A, the second user 504 is positioned in a second physical environment 500, different from the first physical environment, that includes desk 506 and mobile electronic device 560. Additionally, as shown in FIG. 5A and as indicated in overhead view 512, the second electronic device 101b that includes display 120b is positioned on the desk 506 in the second physical environment 500. In some examples, as shown in FIG. 5A, the second user 504 is currently not using (e.g., wearing) the second electronic device 101b in the second physical environment 500. Additionally, in FIG. 5A, the second user 504 is positioned in front of the desk 506 facing toward the second electronic device 101b and the mobile electronic device 560. In some examples, the second electronic device 101b is configured to communicate with the mobile electronic device 560. In some examples, the second electronic device 101b and the mobile electronic device are associated with a same user account associated with the second user 504. For example, the second user 504 is logged into the same user account on the second electronic device 101b and the mobile electronic device 560. In the example of FIG. 5A, the second electronic device 101b is powered on (e.g., in a sleep state or low power state).

In FIG. 5A, the first electronic device 101a detects an input corresponding to a request to display a user interface via which to initiate communication with a respective user based on user availability in the three-dimensional environment 550A. For example, as shown in FIG. 5A, the first electronic device 101a detects a press of hardware element 540a (e.g., a physical button of the first electronic device 101a) provided by hand 503 of the first user 502.

In some examples, as shown in FIG. 5B, in response to detecting the selection of the hardware element 540a, the first electronic device 101a displays people picker user interface 530 in the three-dimensional environment 550A. In some examples, the people picker user interface 530 corresponds to the people picker user interface 430 described above. In some examples, as similarly discussed above, the people picker user interface 530 includes a plurality of representations of a plurality of users with which the first user 502 is able to initiate communication in the three-dimensional environment 550A.

In some examples, as shown in FIG. 5B, the plurality of representations of the plurality of users in the people picker user interface 530 includes a first representation 531A of a first user (e.g., Sandy, corresponding to the second user 504 in FIG. 5A). In some examples, as previously discussed above, the user Sandy (e.g., the second user 504) satisfies the one or more first criteria discussed above, indicating that the user Sandy is available for communication with the first user 502 in the three-dimensional environment 550A. For example, as previously discussed above, the first electronic device 101a displays the first representation 531A with visual indication 532A indicating the second user 504 is available for communication. In some examples, though the second electronic device 101b is not currently being worn by the second user 504, as indicated in the overhead view 512 in FIG. 5B, the second user 504 satisfies the one or more first criteria discussed above. For example, as shown in the overhead view 512 in FIG. 5B, the second user 504 is positioned in a field of view of the second electronic device 101b (e.g., and is thus detectable by one or more sensors (e.g., image sensors, such as cameras) of the second electronic device 101b, which are powered on). Additionally or alternatively, in some examples, the second user 504 satisfies the one or more first criteria because the second user 504 is positioned within a threshold distance 515 (e.g., 0.1, 0.2, 0.5, 1, 2, 3, 5, 10, 15, etc. meters) of the second electronic device 101b. Accordingly, as mentioned above, the first representation 531A that is associated with the second user 504 optionally includes the visual indication 532A that indicates that the second user 504 is available for communication.

In FIG. 5B, the first electronic device 101a detects an input corresponding to a request to initiate communication with the second user 504 in the three-dimensional environment 550A. For example, as shown in FIG. 5B, the first electronic device 101a detects an air pinch gesture performed by the hand 503 of the first user 502, optionally while gaze 526 is directed toward the first representation 531A in the three-dimensional environment 550A.

In some examples, as shown in FIG. 5C, in response to detecting the selection of the first representation 531A in the people picker user interface 530, the first electronic device 101a transmits an indication of a request to enter a communication session with the first user 502 to the second electronic device 101b. For example, as shown in FIG. 5C, and as similarly discussed above, the first electronic device 101a displays user interface object 520 indicating that the first electronic device 101a has initiated communication with the second user 504 at the second electronic device 101b. In some examples, as shown in FIG. 5C, in response to receiving the indication of the request to enter the communication session with the first user 502, the second electronic device 101b displays notification 524 that includes first option 525A that is selectable to accept the request and second option 525B that is selectable to deny the request (e.g., and forgo entering the communication session with the first user 502). In some examples, as indicated in FIG. 5C, because the second user 504 is not wearing the second electronic device 101b when the indication of the request is received (e.g., as determined by one or more sensors of the second electronic device 101b as similarly discussed above, such as internal and/or external image sensors 114a-114c), the second electronic device 101b displays the notification 524 on an outer surface of the display 120b (e.g., the surface facing the second user 504 from the viewpoint of the second user 504). For example, the second electronic device 101b displays the notification 524 on a surface that is opposite an inner surface of the display 120b, such as opposite the surface of the display 120b of the second electronic device 101b illustrated in FIGS. 4A-4G. In some examples, as indicated in FIG. 5C, displaying the notification 524 at the second electronic device 101b includes providing sound-based feedback at the second electronic device 101b. For example, the second electronic device 101b outputs, via one or more speakers of the second electronic device 101b, audio 517 that corresponds to a ring, tune, chime, etc. indicative of the incoming request to enter the communication session with the first user 502. In some examples, displaying the notification 524 at the second electronic device 101b includes providing haptic feedback (e.g., vibrational feedback) at the second electronic device 101b.

Additionally or alternatively, in some examples, as shown in FIG. 5C, the mobile electronic device 560 displays the notification 524 (e.g., via a display, such as a touchscreen, of the mobile electronic device 560) that includes the first option 525A and the second option 525B. For example, as shown in FIG. 5C, because the mobile electronic device 560 is in communication with the second electronic device 101b, when the second electronic device 101b receives the request from the first electronic device 101a, the second electronic device 101b transmits a signal or other indication of the request to the mobile electronic device 560, which causes the mobile electronic device 560 to display the notification 524 (e.g., in addition to or as an alternative to the second electronic device 101b displaying the notification 524). Alternatively, in some examples, the mobile electronic device 560 displays the notification 524 (e.g., in addition to or as an alternative to the second electronic device 101b displaying the notification 524) because the mobile electronic device 560 and the second electronic device 101b are associated with a same user account associated with the second user 504, as similarly discussed above.

In FIG. 5C, while the notification 524 is displayed at the second electronic device 101b and/or the mobile electronic device 560, the second electronic device 101b detects interaction with the second electronic device 101b corresponding to association of the second electronic device 101b with a head of the second user 504. For example, as illustrated in FIG. 5C, the second user 504 picks up the second electronic device 101b, such as via hand 505 of the second user 504, and places and/or affixes the second electronic device 101b to the head of the second user 504, as shown in the overhead view 512 in FIG. 5D.

In some examples, as shown in FIG. 5D, when the head of the second user 504 becomes associated with the second electronic device 101b (e.g., the second electronic device 101b is placed on the head of the second user 504), the second electronic device 101b presents, via the display 120b, three-dimensional environment 550B. In some examples, as shown in FIG. 5D, the three-dimensional environment 550B presented using the second electronic device 101b optionally includes captured portions (e.g., captured via external image sensors 114b-ii and 114c-ii) of the second physical environment (e.g., second physical environment 500 above) surrounding the second electronic device 101b, such as a representation of the desk 506 and a representation of the mobile electronic device 560.

In some examples, as shown in FIG. 5D, after displaying the notification 524 in FIG. 5C, the second electronic device 101b begins tracking an elapse of time indicated in time bar 536. As previously discussed herein, in some examples, entering the communication session with the first user 502 at the first electronic device 101a may be in accordance with an “opt out” model of reply. For example, as discussed above, in accordance with a determination that threshold amount of time 537 elapses since the display of the notification 524 at the second electronic device 101b (e.g., and/or the mobile electronic device 560), and without detecting input provided by the second user 504 that indicates denial of the request to enter the communication session with the first user 502, the second electronic device 101b enters the communication session with the first user 502 at the first electronic device 101a.

From FIGS. 5D to 5E, the second electronic device 101b determines that the threshold amount of time 537 has elapsed since the display of the notification 524 and without detecting input provided by the second user 504 indicating denial of the request to enter the communication session with the first user 502. Accordingly, in some examples, the second electronic device 101b transmits an indication of acceptance of the request to the first electronic device 101a, which causes the first electronic device 101a and the second electronic device 101b to establish communication, as indicated in FIG. 5E. In some examples, as shown in FIG. 5E, and as similarly discussed above, when the first electronic device 101a and the second electronic device 101b enter the communication session, the first electronic device 101a displays avatar 514 corresponding to the second user 504 in the three-dimensional environment 550A, and the second electronic device 101b displays avatar 516 corresponding to the first user 502 in the three-dimensional environment 550B. In some examples, the avatars 514/516 have one or more characteristics of the avatars 315/317 discussed above with reference to FIG. 3. In some examples, the communication session has one or more characteristics of the multi-user communication session described above with reference to FIG. 3.

In some examples, the second user 504 is able to provide an indication of a reply to the request to enter communication with the first user 502 at the first electronic device 101a without wearing the second electronic device 101b. For example, in FIG. 5F, while the second electronic device 101b (e.g., and/or the mobile electronic device 560) is displaying the notification 524, the second electronic device 101b detects a selection of the first option 525A. In some examples, as shown in FIG. 5F, the second electronic device 101b detects the selection of the first option 525A via interaction with hardware element 540B (e.g., physical button or dial) of the second electronic device 101b. For example, as shown in FIG. 5F, the second electronic device 101b detects a press (e.g., single press) of the hardware element 540B provided by hand 505A of the second user 504, optionally while the first option 525A has focus (e.g., is displayed with an indication of focus in the notification 524). Alternatively, in some examples, the second electronic device 101b detects a selection of the first option 525A via an air gesture performed by hand 505B of the second user 504. For example, as shown in FIG. 5F, the second electronic device 101b detects the hand 505B perform an air tap gesture directed to the first option 525A that is displayed on the outer surface of the display 120b as discussed above. In some examples, the second electronic device 101b detects the air gesture performed by the hand 505B via one or more image sensors of the second electronic device 101b (e.g., one or more cameras, similar to external image sensors 114b-ii and 114c-ii discussed above) that are activated when the notification 524 is displayed by the second electronic device 101b.

Alternatively, in some examples, the mobile electronic device 560 detects a selection of the first option 525A in the notification 524 (e.g., rather than the second electronic device 101b detecting the selection in the manner discussed above). In some examples, as shown in FIG. 5F, the mobile electronic device 560 detects the selection of the first option 525A via a tap of a contact directed to the first option 525A, such as via a tap of a finger of the hand 505B on the touchscreen of the mobile electronic device 560 directed to the first option 525A. It should be understood that the mobile electronic device 560 detects the selection of the first option 525A via alternative methods, such as via a click or press of a button on an input device in communication with the mobile electronic device 560 (e.g., mouse or trackpad press).

In some examples, in response to detecting the selection of the first option 525A (e.g., at the second electronic device 101b or the mobile electronic device 560), the second electronic device 101b transmits an indication of acceptance of the request to enter communication with the first user 502 to the first electronic device 101a, as similarly discussed above. In some examples, as shown in FIG. 5G, when the first electronic device 101a and the second electronic device 101b enter the communication session, the first user 502 and the second user 504 are represented non-spatially at their respective electronic devices. For example, as shown in FIG. 5G, the first electronic device 101a and the second electronic device 101b forgo displaying avatars (e.g., three-dimensional representations) of the users in the communication session. Rather, as shown in FIG. 5G, the first electronic device 101a displays virtual conferencing user interface 542 in the three-dimensional environment 550A, which includes a two-dimensional representation of the second user 504. For example, in FIG. 5G, the virtual conferencing user interface 542 includes a two-dimensional image (e.g., photograph, icon, cartoon, sketch, etc.) of the second user 504. In some examples, the virtual conferencing user interface 542 includes a two-dimensional camera feed of a field of view of the one or more cameras of the second electronic device 101b, which includes the second user 504 who is positioned in the field of view of the one or more cameras. Additionally, in some examples, the virtual conferencing user interface 542 includes a plurality of controls that is selectable to perform one or more operations associated with the communication session. For example, as shown in FIG. 5G, the virtual conferencing user interface 542 includes option 543A that is selectable to change and/or select an audio output source (e.g., speakers, headphones, etc.), option 543B that is selectable to turn on or off a video feed of the first user 502 (e.g., control one or more cameras of the first electronic device 101a), option 543C that is selectable to mute a voice of the first user 502 (e.g., control one or more microphones of the first electronic device 101a), option 543D that is selectable to share content with the second user 504 (e.g., such as perform a screensharing operation), and/or option 543E that is selectable to end the communication session between the first user 502 and the second user 504.

Similarly, as shown in FIG. 5G, in some examples, the second electronic device 101b and/or the mobile electronic device 560 display conferencing user interface 544 that corresponds to and/or includes a two-dimensional representation of the first user 502. For example, as shown in FIG. 5G, the conferencing user interface 544 includes an image of the first user 502 or a video feed of one or more cameras of the first electronic device 101a that includes the first user 502 (e.g., as captured by image sensors 114a-i) or a representation of the first user 502 (e.g., a two-dimensional avatar of the first user 502). Additionally, in some examples, as shown in FIG. 5G, the conferencing user interface 544 includes a plurality of controls that is selectable to perform one or more operations associated with the communication session, such as options 545A-545E (e.g., corresponding to the options 543A-543E discussed above). In some examples, as shown in FIG. 5G, when the second electronic device 101b enters the communication session with the first electronic device 101a, the second electronic device 101b (e.g., and/or the mobile electronic device 560) outputs audio 517 corresponding to a voice of the second user 504. For example, the audio 517 includes speech captured by one or more microphones of the first electronic device 101a that is transmitted (e.g., wirelessly) to the second electronic device 101b for outputting at the second electronic device 101b (e.g., and/or the mobile electronic device 560) while the communication session is active.

In FIG. 5G, while the second electronic device 101b is in the communication session with the first electronic device 101a, the second electronic device 101b detects interaction with the second electronic device 101b corresponding to association of the second electronic device 101b with a head of the second user 504. For example, as illustrated in FIG. 5G, the second user 504 picks up the second electronic device 101b, such as via the hand 505 of the second user 504, and places and/or affixes the second electronic device 101b to the head of the second user 504, as shown in the overhead view 512 in FIG. 5H.

In some examples, as shown in FIG. 5H, when the head of the second user 504 becomes associated with the second electronic device 101b (e.g., the second electronic device 101b is placed on the head of the second user 504), the second electronic device 101b presents, via the display 120b, the three-dimensional environment 550B. In some examples, as shown in FIG. 5H, the three-dimensional environment 550B presented using the second electronic device 101b optionally includes captured portions (e.g., captured via external image sensors 114b-ii and 114c-ii) of the second physical environment (e.g., second physical environment 500 above) surrounding the second electronic device 101b, such as a representation of the desk 506 and a representation of the mobile electronic device 560. Additionally, in some examples, as illustrated in FIG. 5H, when the second electronic device 101b is positioned on the head of the second user 504, the communication session between the first electronic device 101a and the second electronic device 101b is transitioned to a spatial communication session. In some examples, transitioning to a spatial communication session includes representing the participants in the communication session as three-dimensional representations having spatial truth in the shared three-dimensional environment. For example, as shown in FIG. 5H, the first electronic device 101a displays the avatar 514 of the second user 504 in the three-dimensional environment 550A (e.g., in place of the virtual conferencing user interface 542) and the second electronic device 101b displays the avatar 516 of the first user 502 in the three-dimensional environment 550B (e.g., and ceases display of the conferencing user interface 544 on the outer surface of the display 120b).

FIGS. 51-5J illustrate an example of the second user 504 providing an input corresponding to a denial of the request from the first user 502 to enter a communication session. For example, in FIG. 5I, while the second electronic device 101b and/or the mobile electronic device 560 are displaying the notification 524 corresponding to the request to enter the communication session with the first user 502, the second electronic device 101b and/or the mobile electronic device 560 detect an input corresponding to denial of the request from the first user 502 to enter the communication session. In some examples, as similarly discussed above, the input includes or corresponds to interaction with the hardware element 540B of the second electronic device 101b. For example, as shown in FIG. 5I, the second electronic device 101b detects a press, rotation, and/or click of the hardware element 540B provided by hand 505A of the second user 504, optionally while the second option 525B has the focus in the notification 524. Alternatively, in some examples, as shown in FIG. 5I, the second electronic device 101b (e.g., and/or the mobile electronic device 560) detects a selection of the second option 525B provided by hand 505B of the second user 504. For example, as shown in FIG. 5I, the second electronic device 101b detects an air gesture, such as an air tap gesture or an air pinch gesture, performed by the hand 505B directed to the second option 525B (e.g., detected via the one or more cameras of the second electronic device 101b). In some examples, the mobile electronic device 560 detects the selection of the second option 525B performed by the hand 505B via an input device of the mobile electronic device 560, such as a touchscreen, touchpad, mouse, or other button of the mobile electronic device 560. For example, in FIG. 5I, the mobile electronic device 560 detects a tap of a contact (e.g., finger of the hand 505B) directed to the second option 525B on a touchscreen of the mobile electronic device 560. In some examples, as indicated in FIG. 5I, the second electronic device 101b (e.g., and/or the mobile electronic device 560) detects the selection of the second option 525B before threshold amount of time 537 in time bar 536 elapses since the display of the notification 524, as similarly discussed above.

In some examples, as shown in FIG. 5J, in response to detecting the selection of the second option 525B in the notification 524 before the threshold amount of time 537 has elapsed since the display of the notification 524, the second electronic device 101b transmits an indication of the denial of the request to enter the communication session with the first user 502 to the first electronic device 101a. Additionally, in some examples, as shown in FIG. 5J, the second electronic device 101b forgoes displaying a visual representation (e.g., an avatar or a two-dimensional user interface) of the first user 502 (e.g., on the outward facing surface of the display 120b). In some examples, as shown in FIG. 5J, when the first electronic device 101a receives the indication of the denial of the request from the second electronic device 101b, the first electronic device 101a displays message element 518 in the three-dimensional environment 550A that includes a default reply (e.g., not necessarily selected by the second user 504) (e.g., “User 2 is unavailable”). Additionally, as similarly discussed above, because the second electronic device 101b forgoes entering the communication session with the first electronic device 101a, the first electronic device 101a forgoes displaying a visual representation of the second user 504 in the three-dimensional environment 550A.

Accordingly, as outlined above, providing a method for easily and efficiently initiating communication between users at their respective electronic devices, without requiring a recipient user of the communication request to be actively wearing their electronic device, which helps simplify and/or reduce user interactions needed to initiate the communication, as one benefit.

It is understood that the examples shown and described herein are merely exemplary and that additional and/or alternative elements may be provided within the three-dimensional environment for initiating communication between users. It should be understood that the appearance, shape, form, and size of each of the various user interface elements and objects shown and described herein are exemplary and that alternative appearances, shapes, forms and/or sizes may be provided. For example, the virtual objects representative of user interfaces (e.g., user interface objects 420 and 520 and/or conferencing user interfaces 542 and 544) may be provided in an alternative shape than a rectangular shape, such as a circular shape, triangular shape, etc. In some examples, the various selectable affordances (e.g., selectable options 425A, 425B, 525A, 525B, 543A-543E and/or 545A-545E) described herein may be selected verbally via user verbal commands (e.g., “select option” or “select virtual object” verbal command). Additionally or alternatively, in some examples, the various options, user interface elements, control elements, etc. described herein may be selected and/or manipulated via user input received via one or more separate input devices in communication with the electronic device(s). For example, selection input may be received via physical input devices, such as a mouse, trackpad, keyboard, etc. in communication with the electronic device(s).

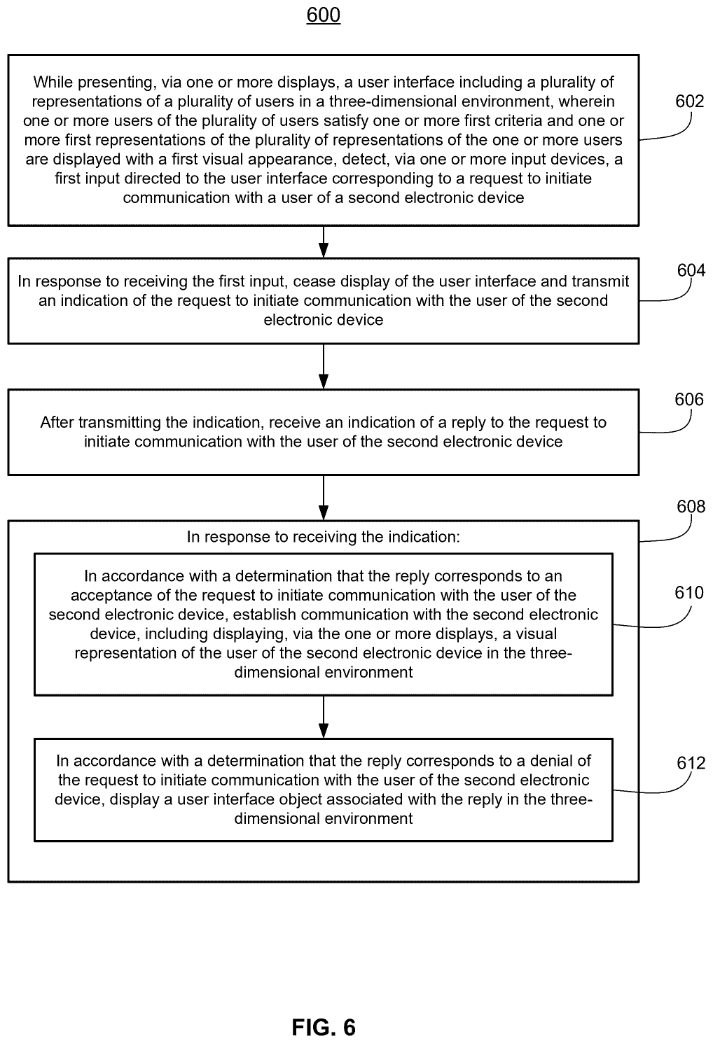

FIG. 6 illustrates a flow diagram illustrating an example process for facilitating transmitting a request to initiate communication between users virtually in a three-dimensional environment according to some examples of the disclosure. In some examples, process 600 begins at a first electronic device in communication with one or more displays and one or more input devices. In some examples, the first electronic device and the second electronic device are optionally a head-mounted display similar or corresponding to electronic devices 260 and 270 of FIG. 2 and/or electronic device 101 of FIG. 1. As shown in FIG. 6, in some examples, at 602, while presenting, via the one or more displays, a user interface including a plurality of representations of a plurality of users in a three-dimensional environment, wherein one or more users of the plurality of users satisfy one or more first criteria and one or more first representations of the plurality of representations of the one or more users are displayed with a first visual appearance, the first electronic device detects, via the one or more input devices, a first input directed to the user interface corresponding to a request to initiate communication with a user of a second electronic device. For example, as shown in FIG. 4B, while first electronic device 101a is displaying people picker user interface 430 in three-dimensional environment 450A, the first electronic device 101a detects a selection of first representation 431A corresponding to second user 404 in FIG. 4A provided by hand 403 of first user 402, wherein the second user 404 is currently available for communication.

In some examples, at 604, in response to receiving the first input, the first electronic device ceases display of the user interface and transmits an indication of the request to initiate communication with the user of the second electronic device. For example, as shown in FIG. 4C, the first electronic device 101a displays user interface object 420 indicating that the indication of the request to initiate communication with the second user 404 has been transmitted to the second electronic device 101b, after ceasing display of the people picker user interface 430 in the three-dimensional environment 450A. In some examples, at 606, after transmitting the indication, the first electronic device 101a receives an indication of a reply to the request to initiate communication with the user of the second electronic device. For example, as shown in FIG. 4C, the second electronic device 101b detects an input provided by the second user 504 corresponding to a reply to the request via user interface object 422.

In some examples, at 608, in response to receiving the indication, at 610, in accordance with a determination that the reply corresponds to an acceptance of the request to initiate communication with the user of the second electronic device, the first electronic device 101a establishes communication with the second electronic device, including displaying, via the one or more displays, a visual representation of the user of the second electronic device in the three-dimensional environment. For example, as shown in FIG. 4D, in response to receiving an indication of the selection of the first option 423A in the user interface object 422 detected at the second electronic device 101b, the first electronic device 101a displays avatar 414 of the second user 404 in the three-dimensional environment 450A. In some examples, at 612, in accordance with a determination that the reply corresponds to a denial of the request to initiate communication with the user of the second electronic device, the first electronic device displays a user interface object associated with the reply in the three-dimensional environment. For example, as shown in FIG. 4G, in response to receiving an indication of selection of the second option 423B in the user interface object 422 detected at the second electronic device 101b in FIG. 4E, the first electronic device 101a displays message element 418 indicating that the second user 404 is not available for communication.

It is understood that process 600 is an example and that more, fewer, or different operations can be performed in the same or in a different order. Additionally, the operations in process 600 described above are, optionally, implemented by running one or more functional modules in an information processing apparatus such as general-purpose processors (e.g., as described with respect to FIG. 2) or application specific chips, and/or by other components of FIG. 2.

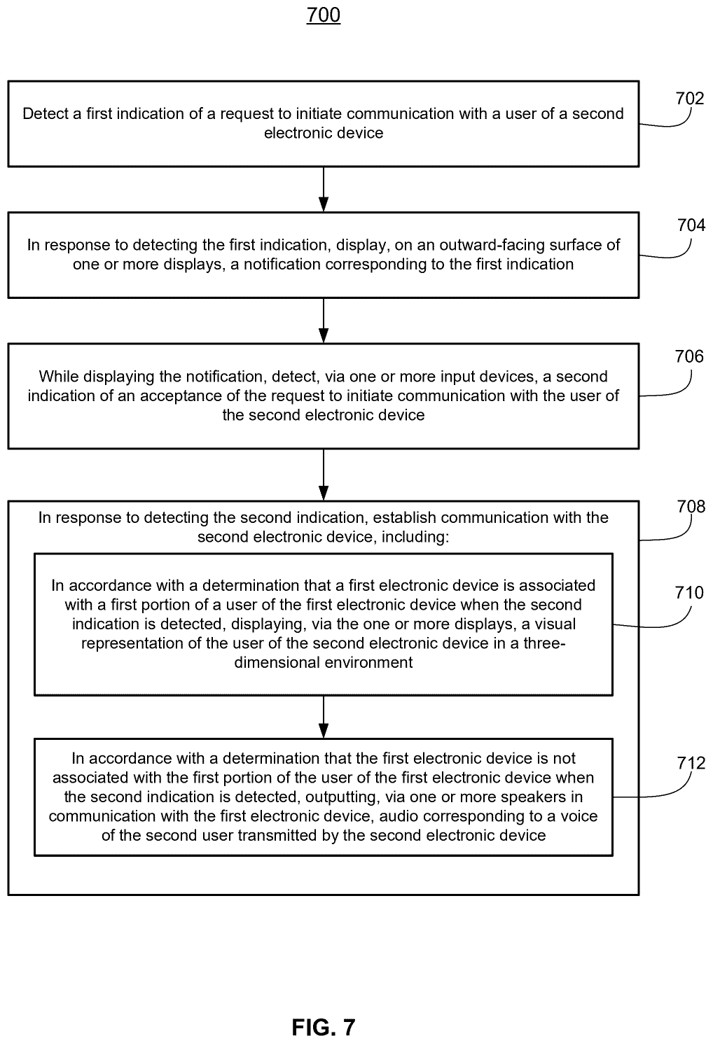

FIG. 7 illustrates a flow diagram illustrating an example process for facilitating response to a request to initiate communication between users virtually in a three-dimensional environment according to some examples of the disclosure. In some examples, process 700 begins at a first electronic device in communication with one or more displays and one or more input devices. In some examples, the first electronic device and the second electronic device are optionally a head-mounted display similar or corresponding to electronic devices 260 and 270 of FIG. 2 and/or electronic device 101 of FIG. 1. As shown in FIG. 7, in some examples, at 702, the first electronic device detects a first indication of a request to initiate communication with a user of a second electronic device. For example, from FIG. 5B to FIG. 5C, second electronic device 101b detects an indication of a request to initiate communication with first user 502 of first electronic device 101a.

In some examples, at 704, in response to detecting the first indication, the first electronic device displays, on an outward-facing surface of the one or more displays, a notification corresponding to the first indication. For example, as shown in FIG. 5C, the second electronic device 101b displays notification 524 on an outward-facing surface of display 120b. In some examples, at 706, while displaying the notification, the first electronic device detects, via the one or more input devices, a second indication of an acceptance of the request to initiate communication with the user of the second electronic device. For example, as illustrated in FIG. 5C, the second electronic device 101b detects an input provided by hand 505 of the second user 504 corresponding to an acceptance of the request to initiate communication with the first user 502.

In some examples, at 708, in response to detecting the second indication, the first electronic device establishes communication with the second electronic device. In some examples, at 710, in accordance with a determination that the first electronic device is associated with a first portion of a user of the first electronic device when the second indication is detected, the first electronic device displays, via the one or more displays, a visual representation of the user of the second electronic device in a three-dimensional environment. For example, as shown in FIG. 5E, in response to detecting the second user 504 place the second electronic device 101b on the head of the second user 504 in FIG. 5D, the second electronic device 101b displays avatar 516 of the first user 502 in three-dimensional environment 550B. In some examples, at 712, in accordance with a determination that the first electronic device is not associated with the first portion of the user of the first electronic device when the second indication is detected, the first electronic device outputs, via one or more speakers in communication with the first electronic device, audio corresponding to a voice of the second user transmitted by the second electronic device. For example, as shown in FIG. 5G, in response to detecting selection of first option 525A in the notification 524 provided by the second user 504 without detecting the second user 504 place the second electronic device 101b on the head of the second user 504 in FIG. 5F, the second electronic device 101b outputs audio 517 corresponding to a voice of the first user 502 that is transmitted by the first electronic device 101a.

It is understood that process 700 is an example and that more, fewer, or different operations can be performed in the same or in a different order. Additionally, the operations in process 700 described above are, optionally, implemented by running one or more functional modules in an information processing apparatus such as general-purpose processors (e.g., as described with respect to FIG. 2) or application specific chips, and/or by other components of FIG. 2.

Therefore, according to the above, some examples of the disclosure are directed to a method comprising, at a first electronic device in communication with one or more displays and one or more input devices: while presenting, via the one or more displays, a user interface including a plurality of representations of a plurality of users in a three-dimensional environment, wherein one or more users of the plurality of users satisfy one or more first criteria and one or more first representations of the plurality of representations of the one or more users are displayed with a first visual appearance, detecting, via the one or more input devices, a first input directed to the user interface corresponding to a request to initiate communication with a user of a second electronic device; in response to receiving the first input, ceasing display of the user interface and transmitting an indication of the request to initiate communication with the user of the second electronic device; after transmitting the indication, receiving an indication of a reply to the request to initiate communication with the user of the second electronic device; and in response to receiving the indication, in accordance with a determination that the reply corresponds to an acceptance of the request to initiate communication with the user of the second electronic device, establishing communication with the second electronic device, including displaying, via the one or more displays, a visual representation of the user of the second electronic device in the three-dimensional environment, and in accordance with a determination that the reply corresponds to a denial of the request to initiate communication with the user of the second electronic device, displaying a user interface object associated with the reply in the three-dimensional environment.

Additionally or alternatively, in some examples, the one or more first criteria are based on an indication of user availability. Additionally or alternatively, in some examples, the one or more first criteria include a criterion that is satisfied when a respective user of the plurality of users is using a respective electronic device configured to communicate with the first electronic device. Additionally or alternatively, in some examples, the one or more first criteria include a criterion that is satisfied when a respective user of the plurality of users is located in a field of view of one or more cameras of a respective electronic device that is associated with the respective user, and wherein the respective electronic device is configured to communicate with the first electronic device. Additionally or alternatively, in some examples, the one or more first criteria include a criterion that is satisfied when a respective user of the plurality of users is within a threshold distance of a respective electronic device that is associated with the respective user, and wherein the respective electronic device is configured to communicate with the first electronic device. Additionally or alternatively, in some examples, the one or more first criteria include a criterion that is satisfied when a communication status of a respective user of the one or more users is a first communication status, and is not satisfied when the communication status of the respective user is a second communication status, different from the first communication status. Additionally or alternatively, in some examples, one or more second representations of the plurality of representations of one or more users of the plurality of users that do not satisfy the one or more first criteria are displayed with a second visual appearance, different from the first visual appearance. Additionally or alternatively, in some examples, displaying the one or more first representations with the first visual appearance includes displaying a visual indication of a first type, and displaying the one or more second representations with the second visual appearance includes displaying a visual indication of a second type, different from the first type. Additionally or alternatively, in some examples, the visual indication of the first type provides an indication that a respective user of the plurality of users is available to receive a communication request, and the visual indication of the second type provides an indication that a respective user of the plurality of users is not available to receive a communication request.

Additionally or alternatively, in some examples, the user interface including the plurality of representations of the plurality of users is displayed in the three-dimensional environment in response to detecting interaction with a hardware element of the first electronic device. Additionally or alternatively, in some examples, the visual representation of the user of the second electronic device corresponds to a three-dimensional avatar of the user of the second electronic device. Additionally or alternatively, in some examples, the user interface object associated with the reply includes a reply message selected by the user of the second electronic device. Additionally or alternatively, in some examples, the user interface object associated with the reply includes an indication that the user of the second electronic device is unavailable for communication. Additionally or alternatively, in some examples, presenting the visual representation of the user of the second electronic device includes outputting, via one or more speakers in communication with the first electronic device, audio corresponding to a voice of the user of the second electronic device. Additionally or alternatively, in some examples, the first electronic device and the second electronic device include head-mounted displays.

Some examples of the disclosure are directed to a method, comprising at a first electronic device in communication with one or more displays and one or more input devices: detecting a first indication of a request to initiate communication with a user of a second electronic device; in response to detecting the first indication, displaying, on an outward-facing surface of the one or more displays, a notification corresponding to the first indication; while displaying the notification, detecting, via the one or more input devices, a second indication of an acceptance of the request to initiate communication with the user of the second electronic device; and in response to detecting the second indication, establishing communication with the second electronic device, including in accordance with a determination that the first electronic device is associated with a first portion of a user of the first electronic device when the second indication is detected, displaying, via the one or more displays, a visual representation of the user of the second electronic device in a three-dimensional environment, and in accordance with a determination that the first electronic device is not associated with the first portion of the user of the first electronic device when the second indication is detected, outputting, via one or more speakers in communication with the first electronic device, audio corresponding to a voice of the user of the second electronic device transmitted by the second electronic device.

Additionally or alternatively, in some examples, the first electronic device is in communication with a mobile electronic device when the first indication is detected by the first electronic device, and a second notification corresponding to the first indication is concurrently displayed via a display of the mobile electronic device when the first indication is detected by the first electronic device. Additionally or alternatively, in some examples, detecting the second indication of the acceptance of the request to initiate communication with the user of the second electronic device includes receiving, from the mobile electronic device, a respective indication of input directed to the second notification detected by the mobile electronic device. Additionally or alternatively, in some examples, the determination that the first electronic device is associated with the first portion of the user of the first electronic device when the second indication is detected includes detecting the first electronic device is worn on a head of the user of the first electronic device. Additionally or alternatively, in some examples, detecting the second indication of the acceptance of the request to initiate communication with the user of the second electronic device includes determining that a threshold amount of time has elapsed since detecting the first electronic device being worn on the head of the user of the first electronic device. Additionally or alternatively, in some examples, the method further comprises: in accordance with the determination that the first electronic device is not associated with the first portion of the user of the first electronic device when the second indication is detected, activating one or more microphones in communication with the first electronic device; while the one or more microphones are active, detecting, via the one or more microphones, speech input provided by the user of the first electronic device; and in response to detecting the speech input, transmitting, to the second electronic device, data indicative of audio corresponding to the speech input.

Additionally or alternatively, in some examples, detecting the second indication of the acceptance of the request to initiate communication with the user of the second electronic device includes detecting interaction with a hardware element of the first electronic device. Additionally or alternatively, in some examples, detecting the second indication of the acceptance of the request to initiate communication with the user of the second electronic device includes detecting, via the one or more input devices, an air gesture performed by the user of the first electronic device directed to the notification. Additionally or alternatively, in some examples, the method further comprises in accordance with the determination that the first electronic device is not associated with the first portion of the user of the first electronic device when the second indication is detected, displaying, on the outward-facing surface of the one or more displays, a user interface of a communication application that includes a visual indication of the user of the second electronic device. Additionally or alternatively, in some examples, the method further comprises: while displaying the user interface of the communication application that includes a visual indication of the user of the second electronic device, detecting, via the one or more input devices, an air gesture performed by the user of the first electronic device directed to the user interface; and in response to detecting the air gesture, performing an operation in the user interface in accordance with the air gesture. Additionally or alternatively, in some examples, the method further comprises: after establishing communication with the second electronic device and while the first electronic device is not associated with the first portion of the user of the first electronic device, detecting, via the one or more input devices, association of the first electronic device with the first portion of the user of the first electronic device; and in response to detecting the association of the first electronic device with the first portion of the user, displaying, via the one or more displays, the visual representation of the user of the second electronic device in the three-dimensional environment, while continuing to output the audio corresponding to the voice of the user of the second electronic device transmitted by the second electronic device.

Additionally or alternatively, in some examples, the method further comprises: while the first electronic device is associated with the first portion of the user of the first electronic device, detecting a third indication of a request to initiate communication with a user of a third electronic device, different from the second electronic device; in response to detecting the third indication, displaying, via the one or more displays, a second notification corresponding to the third indication; while displaying the second notification, detecting, via the one or more input devices, a fourth indication of a reply to the request to initiate communication with the user of the third electronic device; and in response to detecting the fourth indication, in accordance with a determination that the reply corresponds to an acceptance of the request to initiate communication with the user of the third electronic device, establishing communication with the third electronic device, including displaying, via the one or more displays, a visual representation of the user of the third electronic device in the three-dimensional environment. Additionally or alternatively, in some examples, detecting the fourth indication of the reply that corresponds to the acceptance of the request to initiate communication with the user of the third electronic device includes determining that a threshold amount of time has elapsed since displaying the second notification corresponding to the third indication. Additionally or alternatively, in some examples, the method further comprises in response to detecting the fourth indication, in accordance with a determination that the reply corresponds to a denial of the request to initiate communication with the user of the third electronic device, displaying, via the one or more displays, one or more options for transmitting a user-selected reply to the request to the third electronic device. Additionally or alternatively, in some examples, detecting the fourth indication of the reply that corresponds to the denial of the request to initiate communication with the user of the third electronic device includes detecting, via the one or more input devices, an input corresponding to a selection of a deny option in the second notification within a threshold amount of time of displaying the second notification.

Some examples of the disclosure are directed to an electronic device, comprising: one or more processors; memory; and one or more programs stored in the memory and configured to be executed by the one or more processors, the one or more programs including instructions for performing any of the above methods.

Some examples of the disclosure are directed to a non-transitory computer readable storage medium storing one or more programs, the one or more programs comprising instructions, which when executed by one or more processors of an electronic device, cause the electronic device to perform any of the above methods.

Some examples of the disclosure are directed to an electronic device, comprising one or more processors, memory, and means for performing any of the above methods.

Some examples of the disclosure are directed to an information processing apparatus for use in an electronic device, the information processing apparatus comprising means for performing any of the above methods.

The present disclosure contemplates that in some instances, the data utilized may include personal information data that uniquely identifies or can be used to contact or locate a specific person. Such personal information data can include demographic data, content consumption activity, location-based data, telephone numbers, email addresses, twitter ID's, home addresses, data or records relating to a user's health or level of fitness (e.g., vital signs measurements, medication information, exercise information), date of birth, or any other identifying or personal information. Specifically, as described herein, one aspect of the present disclosure is tracking a user's activity and/or availability.

The present disclosure recognizes that the use of such personal information data, in the present technology, can be used to the benefit of users. For example, personal information data may be used to display a visual indication of user availability that changes based on changes in a user's current activity and/or device usage. For example, the visual indication is updated in appearance based on changes to the user's location, activity level, device usage, and/or other user interactions.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates examples in which users selectively block the use of, or access to, personal information data. That is, the present disclosure contemplates that hardware and/or software elements can be provided to prevent or block access to such personal information data. For example, the present technology can be configured to allow users to select to “opt in” or “opt out” of participation in the collection of personal information data during registration for services or anytime thereafter. In another example, users can select not to enable recording of personal information data in a specific application (e.g., first application and/or second application). In addition to providing “opt in” and “opt out” options, the present disclosure contemplates providing notifications relating to the access or use of personal information. For instance, a user may be notified upon initiating collection that their personal information data will be accessed and then reminded again just before personal information data is accessed by the device(s).

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

The foregoing description, for purpose of explanation, has been described with reference to specific examples. However, the illustrative discussions above are not intended to be exhaustive or to limit the disclosure to the precise forms disclosed. Many modifications and variations are possible in view of the above teachings. The examples were chosen and described in order to best explain the principles of the disclosure and its practical applications, to thereby enable others skilled in the art to best use the disclosure and various described examples with various modifications as are suited to the particular use contemplated.

What is claimed is:

1. A method comprising:
at a first electronic device in communication with one or more displays and one or more input devices:
while presenting, via the one or more displays, a user interface including a plurality of representations of a plurality of users in a three-dimensional environment, wherein one or more users of the plurality of users satisfy one or more first criteria and one or more first representations of the plurality of representations of the one or more users are displayed with a first visual appearance, detecting, via the one or more input devices, a first input directed to the user interface corresponding to a request to initiate communication with a user of a second electronic device;
in response to receiving the first input, ceasing display of the user interface and transmitting an indication of the request to initiate communication with the user of the second electronic device;
after transmitting the indication, receiving an indication of a reply to the request to initiate communication with the user of the second electronic device; and
in response to receiving the indication:
in accordance with a determination that the reply corresponds to an acceptance of the request to initiate communication with the user of the second electronic device, establishing communication with the second electronic device, including displaying, via the one or more displays, a visual representation of the user of the second electronic device in the three-dimensional environment; and
in accordance with a determination that the reply corresponds to a denial of the request to initiate communication with the user of the second electronic device, displaying a user interface object associated with the reply in the three-dimensional environment.

2. The method of claim 1, wherein the one or more first criteria are based on an indication of user availability.

3. The method of claim 2, wherein the one or more first criteria include:
a criterion that is satisfied when a respective user of the plurality of users is using a respective electronic device configured to communicate with the first electronic device;
a criterion that is satisfied when a respective user of the plurality of users is located in a field of view of one or more cameras of a respective electronic device that is associated with the respective user, and wherein the respective electronic device is configured to communicate with the first electronic device;
a criterion that is satisfied when a respective user of the plurality of users is within a threshold distance of a respective electronic device that is associated with the respective user, and wherein the respective electronic device is configured to communicate with the first electronic device; and/or
a criterion that is satisfied when a communication status of a respective user of the one or more users is a first communication status, and is not satisfied when the communication status of the respective user is a second communication status, different from the first communication status.

4. The method of claim 1, wherein one or more second representations of the plurality of representations of one or more users of the plurality of users that do not satisfy the one or more first criteria are displayed with a second visual appearance, different from the first visual appearance.

5. The method of claim 4, wherein:
displaying the one or more first representations with the first visual appearance includes displaying a visual indication of a first type; and
displaying the one or more second representations with the second visual appearance includes displaying a visual indication of a second type, different from the first type.

6. The method of claim 5, wherein:
the visual indication of the first type provides an indication that a respective user of the plurality of users is available to receive a communication request; and
the visual indication of the second type provides an indication that a respective user of the plurality of users is not available to receive a communication request.

7. The method of claim 1, wherein the user interface object associated with the reply includes:
a reply message selected by the user of the second electronic device; and/or
an indication that the user of the second electronic device is unavailable for communication.

8. The method of claim 1, wherein presenting the visual representation of the user of the second electronic device includes outputting, via one or more speakers in communication with the first electronic device, audio corresponding to a voice of the user of the second electronic device.

9. A first electronic device comprising:
one or more processors;
memory; and
one or more programs stored in the memory and configured to be executed by the one or more processors, the one or more programs including instructions for performing a method comprising:
while presenting, via one or more displays, a user interface including a plurality of representations of a plurality of users in a three-dimensional environment, wherein one or more users of the plurality of users satisfy one or more first criteria and one or more first representations of the plurality of representations of the one or more users are displayed with a first visual appearance, detecting, via one or more input devices, a first input directed to the user interface corresponding to a request to initiate communication with a user of a second electronic device;
in response to receiving the first input, ceasing display of the user interface and transmitting an indication of the request to initiate communication with the user of the second electronic device;
after transmitting the indication, receiving an indication of a reply to the request to initiate communication with the user of the second electronic device; and
in response to receiving the indication:
in accordance with a determination that the reply corresponds to an acceptance of the request to initiate communication with the user of the second electronic device, establishing communication with the second electronic device, including displaying, via the one or more displays, a visual representation of the user of the second electronic device in the three-dimensional environment; and
in accordance with a determination that the reply corresponds to a denial of the request to initiate communication with the user of the second electronic device, displaying a user interface object associated with the reply in the three-dimensional environment.

10. The first electronic device of claim 9, wherein the one or more first criteria are based on an indication of user availability.

11. The first electronic device of claim 10, wherein the one or more first criteria include:
a criterion that is satisfied when a respective user of the plurality of users is using a respective electronic device configured to communicate with the first electronic device;
a criterion that is satisfied when a respective user of the plurality of users is located in a field of view of one or more cameras of a respective electronic device that is associated with the respective user, and wherein the respective electronic device is configured to communicate with the first electronic device;
a criterion that is satisfied when a respective user of the plurality of users is within a threshold distance of a respective electronic device that is associated with the respective user, and wherein the respective electronic device is configured to communicate with the first electronic device; and/or
a criterion that is satisfied when a communication status of a respective user of the one or more users is a first communication status, and is not satisfied when the communication status of the respective user is a second communication status, different from the first communication status.

12. The first electronic device of claim 9, wherein one or more second representations of the plurality of representations of one or more users of the plurality of users that do not satisfy the one or more first criteria are displayed with a second visual appearance, different from the first visual appearance.

13. The first electronic device of claim 12, wherein:
displaying the one or more first representations with the first visual appearance includes displaying a visual indication of a first type; and
displaying the one or more second representations with the second visual appearance includes displaying a visual indication of a second type, different from the first type.

14. The first electronic device of claim 13, wherein:
the visual indication of the first type provides an indication that a respective user of the plurality of users is available to receive a communication request; and
the visual indication of the second type provides an indication that a respective user of the plurality of users is not available to receive a communication request.

15. The first electronic device of claim 9, wherein the user interface object associated with the reply includes:
a reply message selected by the user of the second electronic device; and/or
an indication that the user of the second electronic device is unavailable for communication.

16. The first electronic device of claim 9, wherein presenting the visual representation of the user of the second electronic device includes outputting, via one or more speakers in communication with the first electronic device, audio corresponding to a voice of the user of the second electronic device.

17. A non-transitory computer readable storage medium storing one or more programs, the one or more programs comprising instructions, which when executed by one or more processors of a first electronic device, cause the first electronic device to perform a method comprising:
while presenting, via one or more displays, a user interface including a plurality of representations of a plurality of users in a three-dimensional environment, wherein one or more users of the plurality of users satisfy one or more first criteria and one or more first representations of the plurality of representations of the one or more users are displayed with a first visual appearance, detecting, via one or more input devices, a first input directed to the user interface corresponding to a request to initiate communication with a user of a second electronic device;
in response to receiving the first input, ceasing display of the user interface and transmitting an indication of the request to initiate communication with the user of the second electronic device;
after transmitting the indication, receiving an indication of a reply to the request to initiate communication with the user of the second electronic device; and
in response to receiving the indication:
in accordance with a determination that the reply corresponds to an acceptance of the request to initiate communication with the user of the second electronic device, establishing communication with the second electronic device, including displaying, via the one or more displays, a visual representation of the user of the second electronic device in the three-dimensional environment; and
in accordance with a determination that the reply corresponds to a denial of the request to initiate communication with the user of the second electronic device, displaying a user interface object associated with the reply in the three-dimensional environment.

18. The non-transitory computer readable storage medium of claim 17, wherein the one or more first criteria are based on an indication of user availability.

19. The non-transitory computer readable storage medium of claim 18, wherein the one or more first criteria include:
a criterion that is satisfied when a respective user of the plurality of users is using a respective electronic device configured to communicate with the first electronic device;
a criterion that is satisfied when a respective user of the plurality of users is located in a field of view of one or more cameras of a respective electronic device that is associated with the respective user, and wherein the respective electronic device is configured to communicate with the first electronic device;
a criterion that is satisfied when a respective user of the plurality of users is within a threshold distance of a respective electronic device that is associated with the respective user, and wherein the respective electronic device is configured to communicate with the first electronic device; and/or
a criterion that is satisfied when a communication status of a respective user of the one or more users is a first communication status, and is not satisfied when the communication status of the respective user is a second communication status, different from the first communication status.

20. The non-transitory computer readable storage medium of claim 17, wherein one or more second representations of the plurality of representations of one or more users of the plurality of users that do not satisfy the one or more first criteria are displayed with a second visual appearance, different from the first visual appearance.

21. The non-transitory computer readable storage medium of claim 20, wherein:
displaying the one or more first representations with the first visual appearance includes displaying a visual indication of a first type; and
displaying the one or more second representations with the second visual appearance includes displaying a visual indication of a second type, different from the first type.

22. The non-transitory computer readable storage medium of claim 21, wherein:
the visual indication of the first type provides an indication that a respective user of the plurality of users is available to receive a communication request; and
the visual indication of the second type provides an indication that a respective user of the plurality of users is not available to receive a communication request.

23. The non-transitory computer readable storage medium of claim 17, wherein the user interface object associated with the reply includes:
a reply message selected by the user of the second electronic device; and/or
an indication that the user of the second electronic device is unavailable for communication.

24. The non-transitory computer readable storage medium of claim 17, wherein presenting the visual representation of the user of the second electronic device includes outputting, via one or more speakers in communication with the first electronic device, audio corresponding to a voice of the user of the second electronic device.
